(19) United States
(12) Patent Application Publication
(10) Pub. No.: US 2020/0123338 A1
(43) Pub. Date: Apr. 23, 2020

(54) LIQUID-RETAINING ELASTOMERIC COMPOSITIONS, PROCESS OF PREPARATION AND USES THEREOF

(71) Applicant: Technion Research & Development Foundation Limited, Haifa (IL)

(72) Inventors: Michael S. SILVERSTEIN, Zikhron-Yaakov (IL); Sharon NIV, Binyamina (IL)

(73) Assignee: Technion Research & Development Foundation Limited, Haifa (IL)

(21) Appl. No.: 16/629,577

(22) PCT Filed: Jul. 10, 2018
(86) PCT No.: PCT/IL2018/050751

§ 371 Date: Jan. 9, 2020

(30) Foreign Application Priority Data
Jul. 11, 2017 (IL) 253431

(51) Int. Cl. C08J 9/00; C08F 279/02; C08L 51/00

(52) U.S. Cl. CPC C08J 9/0061; C08F 279/02; C08L 51/003; C08L 2203/14; C08J 2351/00; C08J 2205/052; C08L 2201/06

(57) ABSTRACT

Provided are compositions-of-matter comprising a continuous elastomeric matrix that is structurally-templated by an external phase of a high internal phase emulsion (HIPE), and a liquid dispersed and entrapped in the elastomeric matrix in a form of a plurality of discrete liquid-filled voids. Also provided are processes for obtaining said compositions-of-matter and uses thereof.

### FIELD AND BACKGROUND OF THE INVENTION

The present invention, in some embodiments thereof, relates to composite polymeric materials and, more particularly, but not exclusively, to HIPE-derived liquid-retaining elastomeric compositions, process of preparation and uses thereof.

High internal phase emulsions (HIPEs) are typically formed from two immiscible liquids, most often being water as a major dispersed or internal phase, and a highly hydrophobic liquid as a minor continuous or external phase, in the presence of a surfactant which is insoluble in the internal phase. The amount of surfactant needed to stabilize a major phase dispersed within a minor phase may reach up to 30% of the weight of the minor phase. HIPEs can also be stabilized through the formation of Pickering emulsions, as described below.

PolyHIPEs are highly porous polymers synthesized by polymerization of monomers within the external phase of HIPEs with internal phase volumes that are typically greater than 74% by volume of the emulsion. Most polyHIPEs are based on the co-polymerization of hydrophobic monomers and crosslinking co-monomers within the continuous phase of water-in-oil (w/o) HIPEs, followed by the removal of the internal phase, thereby producing a porous air-filled polymer.

A variety of polyHIPEs and polyHIPE-based materials have been synthesized and reported in the art. The porous morphology and properties of a polyHIPE was found to depend, among other factors, on the type and amount of the HIPE-stabilizing amphiphilic surfactant. Such surfactants are often difficult and/or costly to remove. These disadvantages become more acute for polyHIPEs where unusually large quantities of surfactant are needed, hence displacing the surfactants in HIPEs can prove advantageous, especially for polyHIPE syntheses.

High internal phase emulsions stabilized by surfactants and polyHIPEs made therefrom are disclosed, for example, in U.S. Patent No. 6,147,131, which teaches porous polymeric materials (foams) made from HIPEs which include water-in-oil high internal phase emulsions having at least 70% of an internal aqueous phase and less than 30% of an external oil phase, wherein the oil phase comprises a vinyl polymerizable monomer and a surfactant effective to stabilize the emulsion, and wherein the surfactants are oil soluble and include an oxyalkylene component.

A Pickering emulsion (named after S.U. Pickering who first described the phenomenon in 1907) is a surfactant-free emulsion stabilized by micro- or nano-scaled solid particles that preferentially migrate to the interface between the two liquid phases. The aforementioned standard amphiphilic surfactants reduce the oil-water interfacial tension. The solid particles of a Pickering emulsion form rigid shells that surround polyhedral or spheroidal droplets of the dispersed phase and prevent coalescence thereof. The particles' shape and size, inter-particle interactions, and the wetting properties of the particles with respect to the liquid phases affect its ability to stabilize HIPEs. The stability of Pickering emulsions based on inorganic particles can be enhanced by chemically modifying the particles' surface with organic moieties that increase their tendency to migrate to the interface, and determines their ability to stabilize oil-in-water (o/w) or water-in-oil (w/o) emulsions.

Several different chemical surface modification methodologies, including silane modification, have been used to change the hydrophilic nature of the surface of silica nanoparticles such that they are able to stabilize Pickering emulsions. Silane coupling agents are commonly used to enhance fiber/matrix adhesion in polymer composites. Alkoxysilanes and chlorosilanes contain groups that bind covalently with silica through reaction with the hydroxyl groups on its surface. These silanes also contain hydrophobic organic groups that decrease surface hydrophilicity. Silane-modification thus enhances the amphiphilic character of the particles' surface, making it more suitable for Pickering emulsions and the corresponding HIPE stabilization. The extent of silica surface reaction with methyldichlorosilane was demonstrated to affect the degree of hydrophobicity and to determine whether it would stabilize an o/w or a w/o Pickering emulsion. In addition to controlling surface hydrophobicity, a silane that bears a vinyl group as part of the chemical surface modification can act as a monomer during a co-polymerization reaction.

Pickering HIPEs containing up to 92% internal phase, stabilized with 1-5% by weight of titania and silica nanoparticles, whose surfaces were modified with oleic acid, have been reported [Menner, A. et al., Chemical Communications, 2007, 4274-4276; and Ikem, V. O. et al., Angewandte Chemie International Edition, 2008, 47, 8277-8279]. Similarly, partially oxidized carbon nanotubes were used to stabilize HIPEs containing up to 60% internal phase [Menner, A. et al., Langmuir, 2007, 23, 2398-2403] and poly(methyl methacrylate) microgel particles were used to stabilize HIPEs containing 50% internal phase [Colver, P. J.; Bon, S. A. F., Chemistry of Materials, 2007, 19, 1537-1539].

Thus, the advantages of using Pickering HIPEs with a relatively small amount of nanoparticles for forming polyHIPEs, include eliminating the need for standard surfactants, eliminating the need for procedures to remove such surfactants, and eliminating the problems associated with residual and leachable surfactants. Most of the polyHIPEs synthesized from such Pickering HIPEs exhibited relatively large voids (300 to 400 μm in diameter). Smaller voids of about 50 μm in diameter were observed when poly(styrene/methyl methacrylate/acrylic acid) particles were used to stabilize Pickering HIPE [Zhang, S.; Chen, J., Chemical Communications, 2009, 2217-2219]. PolyHIPEs from Pickering HIPEs do not usually exhibit the highly interconnected porous structures typical of conventional polyHIPEs but rather exhibit a somewhat interconnected structure.

U.S. Pat. No. 6,353,037 and WO 2002/008321 teach methods for making foams which include functionalized metal oxide nanoparticles by photo- or thermo-polymerizing emulsions comprising a reactive external phase and an immiscible internal phase. Although mentioning closed-cell structures, the polymeric foams disclosed in these documents are predominantly open-celled structures, wherein most or all of the cells are in unobstructed communication with adjoining cells. “Open-celled structures” are foams wherein the majority of adjoining cells are in open communication with each other; an open-cell foam includes foams made from co-continuous emulsions in which the cell structure is not clearly defined, but there are interconnected channels creating at least one open pathway through the foam. Hence, the cells in the substantially open-celled foam structures disclosed in this document have intercellular windows that are typically large enough to permit fluid transfer from one cell to another within the foam structure. After these foams have been polymerized, the residual immiscible internal phase fluid can be removed from the foam structure by vacuum drying, freeze drying, squeeze drying, microwave drying, drying in a thermal oven, drying with infrared lights, room temperature drying, or a combination of these techniques.

Open-cell polyHIPE structures are demonstrated and presented photographically in a study of HIPEs containing divinylbenzene and 4-vinylbenzyl chloride [Barbetta, A. et al., Chem. Commun., 2000, 221-222].

WO 2009/013500 teaches particle-stabilized high internal phase emulsions (Pickering HIPEs) comprising an internal phase, a continuous phase and particles comprising a core and a coating, wherein the wettability of the core is modulated by the coating of the particles. In the poly-Pickering-foams of WO 2009/013500, thin polymer films are formed in the area of contact points between neighboring internal-phase droplets, which rupture during the vacuum drying process and lead to a partially open porous foam structure of poly-Pickering-HIPEs. Hence, the thin polymer films which surround the droplets and constitutes the voids in the poly-Pickering-HIPEs disclosed in this document are relatively stable while the foam is wet, but as they are put under stress by the mechanical forces arising during the vacuum drying, some are forced to rupture, giving rise to some degree of interconnectivity to neighboring voids, now pores or voids, and allows for the complete removal of the trapped internal aqueous phase.

In previous research, the present inventors investigated the synthesis of rubbery crosslinked polyacrylate materials based on Pickering HIPEs that were stabilized using silane-modified silica nanoparticles [Gurevitch, I.; Silverstein, M. S., J. Polym. Sci. A: Polym. Chem., 2010, 48, 1516-1525]. This publication describes the open-celled, interconnected porous structure and the effects of the synthesis parameters on this structure.

U.S. Pat. No. 9,062,245 to the present assignee and one of the present inventors, which is incorporated herein by reference in its entirety, discloses elastomeric poly-Pickering-HIPEs composed of a continuous elastomeric matrix and a liquid entrapped in closed-cells dispersed throughout the matrix.

Israel Patent Application No. 247302 to the present assignee and one of the present inventors, filed 16 Aug. 2016 to the present assignee, which is incorporated herein by reference in its entirety, disclosed Pickering polyHIPE-based substance-releasing systems capable of releasably encapsulating a highly concentrated solution and/or a room temperature solid while minimizing or avoiding burst release from the closed-cell microstructure of an elastic polyHIPE.

Close-cell polyHIPEs, produced by interfacial step-growth polymerization, have been disclosed in Israel Patent Application No. 247302, to the present assignee, and is incorporated herein by reference in its entirety.

Additional prior art documents include “One-Pot Synthesis of Elastomeric Monoliths Filled with Individually Encapsulated Liquid Droplets” [Gurevitch, I. and Silverstein, M. S., Macromolecules, 2012, 45(16), pp. 6450-6456], “Emulsion-templated porous polymers: A retrospective perspective” [Silverstein, M. S., Polymer, 2014, 55(1), pp. 304-320], U.S. Pat. No. 8,668,916 and U.S. Patent Application Nos. 20090215913 and 20030097103.

### SUMMARY OF THE INVENTION

Provided herein are composite materials comprising an elastomeric and truly-closed-cell polyHIPE matrix devoid of HIPE-stabilizing nanoparticles, which further entraps viscous aqueous liquid in the closed cells.

According to an aspect of some embodiments of the present invention, there is provided a composition-of-matter that includes a continuous elastomeric matrix and a liquid dispersed in the matrix in the form of a plurality of discrete liquid-filled voids, separated by walls of the matrix, such that the elastomeric matrix entraps droplets of the liquid in the voids. The matrix is elastomeric for having a compressive modulus of less than 600±60 MPa, and the composition-of-matter is essentially devoid of HIPE-stabilizing particles/nanoparticles and structurally characterized by a truly-closed-cell microstructure.

In some embodiments, the liquid constitutes at least 25% by volume of the composition-of-matter, or from 25% to 95% by volume of the composition-of-matter.

In some embodiments, the liquid constitutes at least 74% by volume of the composition-of-matter.

In some embodiments, the elastomeric matrix is a copolymer that includes a plurality of residues of at least one oligomer.

In some embodiments, the oligomer is characterized by an average molecular weight that ranges from 100±10 g/mol to 10,000±1,000 g/mol.

In some embodiments, the oligomer is characterized by having a plurality of pendent reactive functional groups.

In some embodiments, the oligomer is selected from the group consisting of an oligomeric polybutadiene, an oligomeric vinyl-terminated polybutadiene, an oligomeric hydroxyl-terminated polydimethylsiloxane, an oligomeric polyisoprene, an oligomeric polychloroprene, an oligomeric nitrile rubber, an oligomeric diene rubber, an oligomeric butadiene-styrene rubber, an oligomeric ethylene-propylene rubber, an oligomeric ethylene-propylene-diene rubber, an oligomeric butyl rubber, an oligomeric polysulfide elastomer, an oligomeric polyurethane elastomer, an oligomeric thermoplastic elastomer, an oligomeric epichlorohydrin rubber, an oligomeric polyacrylic rubber, an oligomeric fluorosilicone rubber, an oligomeric fluoroelastomer, an oligomeric perfluoroelastomer, an oligomeric polyether block amides elastomer, an oligomeric chlorosulfonated polyethylene, an oligomeric ethylene-vinyl acetate elastomer, and any combination thereof.

In some embodiments, the elastomeric matrix is a copolymer that includes a plurality of residues of at least one monomer characterized by forming a homopolymer having a T_{g} lower than 30±5° C.

In some embodiments, the monomer is selected from the group consisting of 2-ethylhexyl acrylate, n-butyl acrylate, ethyl acrylate (EA), hexyl acrylate (HA), lauryl acrylate, lauryl methacrylate, stearyl methacrylate, 2-[[(butylamino)carbonyl]oxy]ethyl acrylate, and any combination thereof.

In some embodiments, the ratio of the oligomer to the monomer ranges from 10:90 to 90:10.

In some embodiments, the elastomeric matrix is characterized by a crosslinking level at a matrix-liquid interface higher relative to a crosslinking level in a bulk thereof.

In some embodiments, the truly-closed-cell microstructure is characterized by a liquid retention of at least 40±4% by weight during at least 3 days under freeze drying conditions.

In some embodiments, the elastomeric matrix is a polymerized external phase of a high internal phase emulsion (HIPE) and having a microstructure of the external phase and the voids being a residue of droplets of an internal phase of the HIPE such that the elastomeric matrix entraps the liquid in the voids.

In some embodiments, the internal phase and/or the external phase includes at least one surfactant.

In some embodiments, the surfactant is characterized by a hydrophilic-lipophilic balance ranging from 3 to 6.

In some embodiments, the surfactant is nonionic surfactant.

In some embodiments, the liquid includes a thickening agent.

In some embodiments, the thickening agent is selected from the group consisting of a polysaccharide, alginate (alginic acid), agar, carrageenan, locust bean gum, a vegetable gum, pectin, gelatin, a polyethylene glycol, a polyacrylic acid, a carbomer, a polyurethane, latex, styrene/butadiene, polyvinyl alcohol, cassein, collagen, albumin, modified castor oil, an organosilicone, and any combination thereof.

In some embodiments, the polysaccharide is alginate.

In some embodiments, the liquid, or the internal phase, is characterized by a viscosity that ranges from 10 cp to 10,000 cp.

In some embodiments, the internal phase includes a polymerization initiator.

In some embodiments, the liquid includes at least one releasable substance.

In some embodiments, the releasable substance is selected from the group consisting of a fertilizer, a pesticide, an herbicide, a phase-change material, a bioactive agent, a drug, an antibiotic agent, a polypeptide, an antibody, a catalyst, an anticorrosion agent, a fire retardant, a sealing agent, an adhesive agent, a colorant, an odoriferous agent, a lubricant and any combination thereof.

In some embodiments, the elastomer is degradable.

In some embodiments, the elastomer includes at least one labile unit and/or at least one polymer-degradation inducing agent.

According to an aspect of some embodiments of the present invention, there is provided a process of preparing the composition-of-matter presented herein, the process includes subjecting a high internal phase emulsion (HIPE) having an internal phase and a polymerizable external phase to polymerization of the polymerizable external phase, wherein the internal phase and the polymerizable external phase are each essentially devoid of HIPE-stabilizing particles, and the polymerization being initiated substantially at an interface between the polymerizable external phase and the internal phase.

In some embodiments, the internal phase is an aqueous internal phase and the polymerizable external phase in an organic polymerizable external phase.

In some embodiments, the volume fraction of the organic polymerizable external phase in the HIPE ranges from 0.25 to 0.95.

In some embodiments, the aqueous internal phase further includes a thickening agent.

In some embodiments, the concentration of the thickening agent is selected such that a ratio V_{org}/V_{aq} ranges from 1,000 to 0.001.

In some embodiments, the thickening agent is selected from the group consisting of a polysaccharide, alginate (alginic acid), agar, carrageenan, locust bean gum, a vegetable gum, pectin, gelatin, a polyethylene glycol, a polyacrylic acid, a carbomer, a polyurethane, latex, styrene/butadiene, polyvinyl alcohol, cassein, collagen, albumin, modified castor oil, an organosilicone, and any combination thereof.

In some embodiments, the polysaccharide is alginate.

In some embodiments, the organic polymerizable external phase includes a surfactant.

In some embodiments, the surfactant is selected from the group consisting of sorbitan monooleate, polyglycerol polyricinoleate, a hydrophobic-hydrophilic block copolymer, and any combination thereof.

In some embodiments, the concentration of the surfactant ranges from 0.01% to 30% of the total weight of the organic polymerizable external phase.

In some embodiments, the aqueous internal phase further includes a water-soluble polymerization initiation agent.

In some embodiments, the water-soluble polymerization initiation agent is selected from the group consisting of a water-soluble peroxide, a water-soluble persulfate, potassium persulfate (KPS), 4,4-azobis(4-cyanovaleric acid) and ammonium persulfate (APS).

In some embodiments, the organic polymerizable external phase is a pre-polymerization mixture which includes at least one monomer characterized by forming a homopolymer having an elastic modulus of less than 600±60 MPa.

In some embodiments, the organic polymerizable external phase is a pre-polymerization mixture which includes at least one monomer characterized by forming a homopolymer having a T_{g} lower than 30±5° C.

In some embodiments, the monomer is selected from the group consisting of an acrylate, a methacrylate and a diene.

In some embodiments, the acrylate is selected from the group consisting of 2-ethylhexyl acrylate (EHA), n-butyl acrylate (nBA), ethyl acrylate (EA) and hexyl acrylate (HA).

In some embodiments, the organic polymerizable external phase is a pre-polymerization mixture which includes at least one oligomer characterized by an average molecular weight that ranges from 100±10 g/mol to 10,000±1,000 g/mol.

In some embodiments, the oligomer is characterized by having a plurality of pendent reactive functional groups.

In some embodiments, the oligomer is selected from the group consisting of an oligomeric polybutadiene, an oligomeric vinyl-terminated polybutadiene, an oligomeric hydroxyl-terminated polydimethylsiloxane, an oligomeric polyisoprene, an oligomeric polychloroprene, an oligomeric nitrile rubber, an oligomeric diene rubber, an oligomeric butadiene-styrene rubber, an oligomeric ethylene-propylene rubber, an oligomeric ethylene-propylene-diene rubber, an oligomeric butyl rubber, an oligomeric polysulfide elastomer, an oligomeric polyurethane elastomer, an oligomeric thermoplastic elastomer, an oligomeric epichlorohydrin rubber, an oligomeric polyacrylic rubber, an oligomeric fluorosilicone rubber, an oligomeric fluoroelastomer, an oligomeric perfluoroelastomer, an oligomeric polyether block amides elastomer, an oligomeric chlorosulfonated polyethylene, an oligomeric ethylene-vinyl acetate elastomer, and any combination thereof.

In some embodiments, the weight ratio of the monomer to the oligomer in the organic polymerizable external phase ranges from 10:90 to 90:10.

In some embodiments, the pre-polymerized mixture further includes a reinforcing agent, a curing agent, a curing accelerator, a catalyst, a tackifier, a plasticizer, a flame retardant, a flow control agent, a filler, organic and inorganic microspheres, organic and inorganic microparticles, organic and inorganic nanoparticles, a conducting agent, a magnetic agent, electrically conductive particles, thermally conductive particles, fibers, an antistatic agent, a antioxidant, a anticorrosion agent, a UV absorber, a colorant and combination thereof.

According to an aspect of some embodiments of the present invention, there is provided a composition-of-matter prepared by the process presented herein.

According to an aspect of some embodiments of the present invention, there is provided an article-of-manufacturing includes the composition-of-matter presented herein.

In some embodiments, the article-of-manufacturing is selected from the group consisting of an agricultural product, an energy absorption and dissipation article, a vibration absorption article, a noise absorption article, a cushioning article, a thermal insulating article, an impact protection article, dampening material, moisture and humidity control material, fire resistant material and any combination thereof.

According to an aspect of some embodiments of the present invention, there is provided a substance-releasing system includes the composition-of-matter presented herein.

In some embodiments, the system is degradable, or the matrix is degradable.

In some embodiments, the system is a fertilizer-releasing system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying figures. With specific reference now to the figures in detail, it is stressed that the particulars shown are by way of example and for purposes of illustrative discussion of embodiments of the invention. In this regard, the description taken with the figures makes apparent to those skilled in the art how embodiments of the invention may be practiced.

In the drawings:

FIG. 1 presents DSC thermograms (first heat) of exemplary surfactant-stabilized polyHIPEs, according to some embodiments of the present invention, comparing the effect of the locus of polymerization initiation on the water retention;

FIG. 2 presents DSC thermograms (second heat) of the surfactant-stabilized polyHIPEs, according to some embodiments of the present invention, comparing the effect of the locus of polymerization initiation on the water retention;

FIGS. 3A-D present SEM micrographs of cryogenic fracture surfaces of exemplary sample PB-30/B/SF (FIGS. 3A-B) and exemplary sample PB-30/K/SF (FIGS. 3C-D);

FIGS. 4A-D present SEM micrographs of cryogenic fracture surfaces of exemplary sample PB-70/B/SF (FIGS. 4A-B) and exemplary sample PB-70/K/SF (FIGS. 4C-D); and

FIG. 5 presents plots of compressive stress-strain curves for exemplary surfactant-stabilized polyHIPEs, according to some embodiments of the present invention and the inset shows the data for low stresses and strains.

### DESCRIPTION OF SPECIFIC EMBODIMENTS OF THE INVENTION

The present invention, in some embodiments thereof, relates to composite polymeric materials and, more particularly, but not exclusively, to HIPE-derived liquid-retaining elastomeric compositions, process of preparation and uses thereof.

The principles and operation of some embodiments of the present invention may be better understood with reference to the figures and accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As discussed hereinabove, polyHIPEs are porous polymers that are typically synthesized within the external phases of high internal phase emulsions (HIPEs), emulsions with over 74% internal phase. Removing the HIPE's internal phase generates the porous structure which, for surfactant-stabilized HIPEs, are usually highly interconnected. More closed-cell-like structures can be generated through synthesis within Pickering HIPEs, HIPEs stabilized through the spontaneous assembly of amphiphilic nanoparticles (NPs) at the oil-water phase interface. Previous studies have shown that the HIPE-stabilizing NPs can also be used to initiate the polymerization and to crosslink the polymer (see, for example, U.S. Pat. No. 9,062,245). Liquid droplet elastomers, or LDEs, are elastomeric monoliths containing about 85% water (the internal phase) in the form of individually encapsulated micrometer-scale liquid-filled voids. The original closed-cell LDEs, such as those disclosed in U.S. Pat. No. 9,062,245, included polyHIPEs based on 2-ethylhexyl acrylate (EHA) synthesized using interfacially initiated free radical polymerization (FRP) within HIPEs stabilized using crosslinking NPs. However, the scarcity of elastomeric polyHIPEs in prior art reflects the challenges involved in such syntheses. One of the objectives of the present invention, is to expand the elastomer-based polyHIPE family. To that end, several elastomer-based systems were investigated, which included examination of various forms of HIPE stabilization, polymerization initiation, and elasticity-setting factors. These elaborate studies converged on systems that employed surfactant-stabilized HIPEs, having a crosslinking oligomer in the external phase and a polymerization initiator in the internal phase such that when polymerization was initiated, the droplets of the internal phase were first encrusted in a whole and non-punctured elastomeric layer, essentially forming a discrete void engulfing the droplets individually. These systems were exemplified by copolymerization of EHA and oligomeric 1,2-polybutadiene (PB) using KPS as an initiator for free radical polymerization (FRP).

The oligomers in the external phase in these systems resulted in the formation of highly or extremely viscous external phases, and therefore, unstable HIPEs. Hence, producing stable, oligomer-containing HIPEs was one of the non-trivial challenges en route to affording the composition-of-matter presented herein.

The breakthrough that enabled HIPE stabilization and polyHIPE formation from these systems was the surprising effect of increasing the viscosity of the internal phase, for example, by introducing a thickening agent into the internal phase, e.g., a polysaccharide, such that its viscosity would be closer to that of the external phase. The porous structure, thermal properties, mechanical properties, and water retention were significantly affected by the locus of initiation (organic phase or interface), the crosslinker content, and the emulsification stabilization strategy (surfactant or NPs). Interfacial initiation produced closed-cell structures and relatively elastomeric polyHIPEs (moduli of about 30 kPa) with enhanced water retention.

As presented hereinabove, the composition-of-matter disclosed in U.S. Pat. No. 9,062,245 was synthesized using relatively low molecular weight monomers, affording liquid-retaining elastomeric Pickering (stabilized using HIPE-stabilizing particles/nanoparticles (NP)) polyHIPEs. However, this approach was not applicable for oligomers (long chain monomers having an average molecular weight of about 100 g/mol, 300 g/mol, 500 g/mol and higher), since these starting materials form organic phases that are viscous, and emulsions based on such oligomer-containing external organic phase are difficult to stabilize. Known solutions to this problem include reducing the viscosity of the external phase by adding a solvent; however, the addition of a solvent can prevent a liquid-retaining elastomer composition from being formed.

In general, polyHIPE-producing systems presented herein consist of two parts, an external phase and an internal phase. The external phase contains the monomers which can include relatively low molecular weight monomers such as acrylates, and oligomers which can include polyacrylates, polydienes, and other oligomeric molecules with reactive ends and/or and pendant functional groups. The external phase typically contains the emulsions stabilizer, which can be a surfactant and/or particles. The internal phase contains the liquid to be encapsulated which can include water, an aqueous solution, or an inorganic melt. In some embodiments, the internal phase contains a thermal polymerization initiator, and in some embodiments, a part of the initiation agents is in/on the stabilizing particles, rendering the presence of an initiator in the internal phase superfluous or optional. The internal phase also includes a thickening agent (e.g., sodium alginate) used to increase the viscosity of the internal phase. The internal phase is added to the external phase dropwise with continuous stirring. The resulting emulsion is placed in an oven for thermally initiated polymerization. Alternatively, an ultraviolet initiation system is used in the internal phase, the external phase, or both, to supplement or replace thermal initiation.

Solving the problem of HIPE instability caused by using oligomers in the organic phase, by adding a thickening agent to the internal aqueous phase, thereby bringing the phase viscosity ratio closer to 1, enabled the production of elastomeric NP-free liquid retaining (truly-closed-cell) polyHIPEs. This surprising finding broadens the scope of the present invention to encompass a wide range of different oligomers for producing polyHIPEs that retain liquids with a wide range of hydrophilic thickening agents, afforded from HIPE systems stabilized with a wide range of surfactants, and particularly devoid of HIPE-stabilizing particles. The ability to successfully incorporate oligomers opens up a wide range of possible elastomeric liquid-retaining compositions-of-matter comprising polymers and copolymers such as, for example, polybutadiene rubber, polyisoprene rubber, neoprene rubber and chloroprene rubber, which were not accessible using relatively low molecular weight monomers.

The presently disclosed composition-of-matter can be used for a wide range of applications, including controlled release systems for fertilizers, pesticides, herbicides and/or water in agriculture, for the storage of inorganic phase change materials for thermal energy storage and release, and many other applications.

Thus, according to an aspect of some embodiments of the present invention, there is provided a composition-of-matter that includes a continuous elastomeric matrix and a liquid dispersed in the matrix in the form of a plurality of discrete liquid-filled voids, separated by walls of the matrix, such that the elastomeric matrix entraps droplets of the liquid in the voids. The matrix is elastomeric for having a compressive modulus of less than 600±60 MPa, and the composition-of-matter is essentially devoid of HIPE-stabilizing particles/nanoparticles and by having a truly-closed-cell microstructure.

HIPE-Templated Polymeric Compositions-Of-Matter:

As known in the art and presented hereinabove, high internal phase emulsions (HIPEs) are concentrated systems of water-in-oil, oil-in-water, or oil-in-oil possessing a large volume of internal, or dispersed phase, with a volume fraction of over 0.74, resulting in the deformation of the dispersed phase droplets into polyhedra or in the formation of a polydisperse droplet size distribution. The dispersed droplets are separated by thin films of continuous phase. As HIPEs are intrinsically unstable, the HIPE is typically stabilized by adding an emulsion stabilizer to either the external phase and/or the internal phase, and preferably the surfactant used as an emulsion stabilizer is insoluble in the internal phase.

As discussed hereinabove, polymer materials can be prepared from HIPEs if one or the other (or both) phases of the emulsion contain polymerizable monomeric species. This process yields a range of foam-like products with widely differing properties. As the concentrated emulsion acts as a scaffold or template, the microstructure of the resultant material is determined largely by the emulsion structure immediately prior to polymerization and through changes that can occur during polymerization and/or during post-polymerization processing.

According to some embodiments of the present invention, the composition-of-matter is characterized and therefore can be structurally identified by its microstructure, which is structurally templated by a high internal phase emulsion (HIPE). A polyHIPE, a continuous polymer envelope surrounding the dispersed droplets of the internal phase, results if the continuous, external phase contains polymerizable monomers. A concentrated latex results if the discrete, internal phase contains polymerizable monomers. The composition-of-matter presented herein comprises a continuous elastomeric (polymeric and elastic) matrix, which is the product of a polymerized external phase of a HIPE. Thus, the continuous elastomeric matrix of the composition-of-matter presented herein includes an elastomeric polyHIPE, and having the shape and microstructure of a predecessor HIPE. By having a microstructure of a polyHIPE, it is meant that the microstructure of the composition-of-matter presented herein results from a polymerization process that occurs within a HIPE.

The composition-of-matter presented herein is HIPE-templated, namely its microstructure is a projection of the microstructure of a HIPE before and after its polymerization. Briefly, a HIPE is a plurality of tightly-packed substantially spheroidal and/or polyhedral droplets of various sizes, constituting the dispersed internal phase, separated by walls of a liquid constituting the continuous external phase. The average size and size distribution of the droplets is controlled by the chemical composition and mechanical treatment of the emulsion phases, and are typically characterized by a population of one or more narrowly distributed sizes. For example, average droplet size and distribution can be controlled by use of emulsion stabilizers (surfactants; surface-active substances, solid particles etc.), which may act to reduce the tendency of the droplets to coalesce.

The term “polyHIPE” can therefore be used as a structural term to describe a highly porous monolithic structure of thin walls separating a collection of tightly-packed voids, referred to herein as the “matrix”. The walls are typically thinner at the closest distance between what was tightly-packed droplets before polymerization, and thicker at the spaces between adjacent droplets. When a HIPE is polymerized to yield a polyHIPE, the same microstructure is substantially preserved. The polymerization of the continuous phase of a HIPE “locks in” the HIPE's droplets before any destabilization through droplet coalescence and/or Ostwald ripening can occur.

Hence, the phrase “structurally-templated by an external phase of a high internal phase emulsion (HIPE)”, or its equivalent term “HIPE-templated”, are expressions of structural definitions rather than a process-related expressions, since they relate the microstructure of the HIPE to the microstructure of the resulting matrix of the composition-of-matter, which is no longer an emulsion but a solid matter, referred to in the context of the present embodiments as a polyHIPE or a continuous elastomeric matrix, or simply as a “matrix”.

In some instances, the thinnest areas some of the walls give way to interconnecting windows connecting droplets in adjacent voids, thereby forming an open-cell microstructure. In the case of open-cell polyHIPEs, when the polyHIPE is dried and the dispersed phase is removed, the droplets leave empty voids in their place, which are interconnected by the windows in the walls, wherein the voids can be referred to as having an open-cell microstructure.

According to some embodiments of the present invention, the microstructure of the polymeric compositions-of-matter is structurally-templated by a water-in-oil (w/o) high internal phase emulsion. In a water-in-oil HIPE the polymerization reaction entraps the dispersed aqueous internal phase, while the polymerized walls serve for the encapsulation thereof.

In the context of embodiments of the present invention, the phrase “HIPE-templated closed-cell composition-of-matter comprising a continuous elastomeric matrix and a plurality of liquid droplets dispersed and entrapped in voids therein”, is used herein to refer to the herein presented macroscopic entity, which includes a polymer being formed from at least one type of monomer that forms an elastomer (polymers with glass transition temperatures (T_{g}) below room temperature and with relatively low extents of crosslinking), and having a closed-cell encapsulated droplets microstructure projected by a predecessor HIPE. The mechanical properties of the composition-of-matter are derived from the structural, mechanical and chemical composition of the matrix and the droplet-entrapping voids. The phrase “HIPE-templated elastomeric composition-of-matter” is used herein interchangeably with the shortened phrases “elastomeric composition-of-matter”, “liquid-entrapping composition-of-matter”, “HIPE-templated composition-of-matter”, or “composition-of-matter”.

In some embodiments of the present invention, the composition-of-matter of comprises at least 74% by volume of the liquid, or at least 76%, 78%, 80%, 82%, 84%, 86%, 88%, or 90% by volume of the liquid.

By definition, a HIPE exhibits at least 74% internal phase, although originally it was 70%. When using emulsion templating to produce porous monolithic medium internal phase emulsions (MIPEs) the internal phase content ranges from 30% to 74%, or from 50% to 70%, and low internal phase emulsions (LIPE) contain internal phase contents that are less than 30%. In the context of embodiments of the present invention, unless stated otherwise, the term “HIPE-templated elastomer/polymer” encompasses, at least in the sense of the structural definition, the microstructure of HIPE-, MIPE- and LIPE-templated microstructures, wherein the lower the internal phase content, the thicker the walls and the better the encapsulation thereon in the elastomer/polymer. In some embodiments, the volume fraction of the organic polymerizable external phase in the HIPE ranges from 0.5 to 0.95.

As used herein, the term “continuous” refers to a macroscopic as well as a microscopic property of the elastomeric matrix forming a part of the composition-of-matter presented herein. According to some embodiments of the present invention, the elastomeric matrix is a continuous mass of the elastomer, as opposed to an assembly or aggregate of discrete bodies which are discontinuous with respect to one-another even if these are in direct contact with one-another. Hence, in the context of embodiments of the present invention, the phrase “continuous elastomeric matrix” refers to a continuous mass of an elastomeric substance.

The term “entrap” and its grammatical inflections, as used in the context of the present invention, relate to any form of accommodating a substance, herein the liquid, within a matrix, herein the continuous elastomeric matrix. As used herein, entrapment of a liquid in a continuous elastomeric matrix, as in the context of the present invention, describes complete integration of the liquid within the elastomeric matrix, such that the entrapped liquid is entirely isolated from the surrounding environment.

In the context of embodiments of the present invention, the liquid cannot escape from the elastomeric matrix by flow; however, the walls of the matrix may be permeable to some extent to some solutes and/or components of the liquid, such as molecules of the major solvent, molecules of minor co-solvents, solute molecules, dissolved gas molecules and other charged or uncharged molecular species which are capable of, at least to some degree, diffusing through the walls of the matrix. Such permeability, solubility, dissolvability or diffusivity may also be influenced by various osmotic pressures and concentration potentials. Still, the loss of mass due to evaporation of the internal phase in LDEs, according to some embodiments of the present invention, is exceedingly slow, and can be regarded as infinite when compared to open-cell polyHIPEs of the same chemical composition.

It is noted herein that in some embodiments, the entrapped liquid may be solid at room temperature, as in the case of some a phase-change materials (PCM), which may be found in the liquid state at moderately elevated temperatures (30-100° C.), particularly at the temperature at which the HIPE is prepared and possibly when it is polymerized. Nonetheless, as long as it was in the liquid form during the formation of the precursor HIPE in the context of embodiments of the present invention, a matrix-entrapped substance is referred to herein as a liquid even if it is a solid at room temperature.

Closed-Cell Microstructure:

In a previous study [Gurevitch, I.; Silverstein, M. S., J. Polym. Sci. A: Polym. Chem., 2010, 48, 1516-1525], the present inventors reported the synthesis of rubbery crosslinked polyacrylate polyHIPEs based on Pickering HIPEs that were stabilized using silane-modified silica nanoparticles. In that study, the nanoparticles were found to form shells around the droplets of the aqueous phase and stabilize the two-phase structure. Although appearing to inherit the microstructure of the HIPE, these polyHIPEs were found to have an open-cell microstructure, hence the liquid internal phase could not be retained in the polyHIPEs for extended periods of time.

In some cases, there may be a difference between the microstructure of a HIPE and the microstructure of the resulting polyHIPE. Ruptures, termed holes, interconnects or windows can develop at the thinnest points of the external phase envelope surrounding the dispersed internal phase (walls) under the right conditions (e.g., appropriate surfactant and internal phase contents). Such holes can also form during post-polymerization processing. The formation of these holes transforms the discrete droplets of the internal phase into a continuous interconnected phase. Removal of the internal phase, which is now continuous, yields an open-cell void structure templated by the droplets that formed the HIPE's internal phase. The holes in the polymer wall yield a highly interconnected porous structure.

A polyHIPE where the polymer walls remain intact, as in the precursor HIPE, is referred to as a closed-cell polyHIPE. The closed-cell microstructure is sometimes misleading when inspected visually under an electron microscope, as the completeness and permeability of the walls is not challenged by mechanical, physical and chemical conditions. Since the voids in a truly-closed-cell microstructure still contain the dispersed phase medium, the impermeability of the cells should be tested by loss of mass of the polyHIPE under drying conditions. A cell structure that visually resembles a closed-cell structure but from which the internal phase can essentially be removed, is termed herein a quasi-closed-cell structure. A truly-closed-cell polyHIPE was first disclosed in U.S. Pat. No. 9,062,245, wherein a Pickering stabilized HIPE was formed under conditions that ensured the locus of initiation of polymerization, and the locus of crosslinking the polymer was at the interface of the phases. It is noted that some of the NPs were driven into the wall during the polymerization and were, therefore, not all precisely at the interface in the polyHIPE.

Thus, a polyHIPE can be designed to have an open-cell microstructure, being essentially a porous material or a foam, a quasi-closed-cell microstructure, characterized by visually resembling a non-open-cell material but whose internal phase can be removed relatively easily yielding air-filled voids as attested by macroscopic property analysis based on mass loss. In contrast, and according to embodiments of the present invention, a closed-cell microstructure, also referred to herein interchangeably as a truly-closed-cell microstructure, is one wherein the voids in the polymer, or at least a major part thereof, are substantially not interconnected and the contents of which is entrapped and cannot be easily removed, as can be attested by macroscopic property analysis based on mass loss.

According to some embodiments, the composition-of-matter is characterized by an elastomeric matrix having a truly-closed-cell microstructure stemming from polymerization of a water-in-oil HIPE, wherein an aqueous composition, which is the remainder of the dispersed aqueous phase of the HIPE, is encapsulated in the voids of the matrix. The aqueous composition may include some of the non-reactive and/or excess reactants part of the dispersed internal aqueous phase left after polymerization of the external organic phase.

According to some embodiments, the continuous walls of the HIPE are preserved intact throughout the polymerization process, thereby forming a closed-cell microstructure. In the case of a closed-cell polyHIPE, when the polyHIPE is dried, the dispersed phase or the remainder thereof, cannot be easily removed as the droplets are entrapped in the voids and surrounded by an elastic polymer. A closed-cell polyHIPE has the capacity to encapsulate the internal (dispersed) phase entrapped in the voids surrounded by the polymeric walls. In some cases, visual inspection of the microstructure of the polyHIPE under an electron microscope may be misleading as to the imperviousness of the walls to the encapsulated medium; therefore, a closed-cell microstructure may be determined based on indirect measurements of the seal tightness of the cells, such as, for example, the period of time during which a given composition-of-matter loses a significant amount of mass due to loss of the entrapped liquid.

Thus, one structural definition for the impermeability or tightness of a closed-cell microstructure may involve an initial mass of the composition-of-matter and the rate of a change in that mass over a period of time during which the composition is subjected to conditions that are conducive of removing (e.g., drying) the entrapped phase. The mass of the entrapped internal phase can be assessed, based on the amount of the internal phase prior to the polymerization step, however, in some embodiments the entrapped liquid is made primarily of a volatile substance which can evaporate to some extent during the HIPE formation and polymerization.

According to some embodiments of the present invention, the composition-of-matter presented herein is considered as having a closed-cell microstructure when it is exposed to vacuum at room temperature and loses less than 50% of its mass over a time period of 7 days. In some embodiments, the desiccating vacuum is lower than 1 atm, typically 0.5-0.05 atm or less.

Another structural definition for the impermeability or tightness of a closed-cell microstructure entrapping an aqueous liquid may involve water retention estimates, the values of which are derived from differential scanning calorimetry (DSC) thermal analysis, or DSC thermograms. This thermoanalytical technique monitors the difference in the amount of heat required to increase the temperature of a sample and a reference is measured as a function of temperature. In the context of some embodiments of the present invention, quantitative analysis of the first and/or second heat DSC thermograms, taken for a composition-of-matter having a truly-closed-cell microstructure, are used to determine the impermeability or tightness of the closed-cell microstructure, as described in the Example section that follows below.

As presented in the Examples section hereinbelow, in order to quantify the liquid retention capacity of the composition-of-matter presented herein as a structural feature, samples thereof were subjected to freeze drying conditions for three days in order to remove the entrapped liquid. This technique successfully removes all the entrapped liquid from the open-cell systems and from systems that seem to be closed-cell under the electron-microscope, but were not truly closed-cell. Any sign of liquid in the matrix after long period of freeze drying is a powerful indication that the microstructure is truly-closed-cell. In the DSC thermograms presented hereinbelow, the heats of the peaks at 0° C. (first heat) was determined in J/g-polyHIPE. Heating to 150° C. was taken as aggressive enough to drive out all water, as seen by the evaporation peaks at 100° C. It is noted that only the samples synthesized using interfacial polymerization initiating agents exhibited these peaks. It is also noted that the peaks disappear in the second heat after evaporation, indicating that the peaks in the first heat are related to water. Since the melting peak is attributed to water, dividing by 334.8 J/(g-water) produces the amount of water in the DSC sample (g-water-retained/g-polyHIPE). The amount of water in the original sample was estimated from the original feed composition (g-water-added/g-polyHIPE). The water in the polyHIPE determined from the DSC was divided by the water in the HIPE feed to yield the fraction of retained water (g-water-retained/g-water-added).

Thus, according to some embodiments of the present invention, the truly-closed-cell microstructure is identified, and quantitatively characterized by a liquid retention (W_{R}) of at least 40±4% by weight during at least 3 days under freeze drying conditions, wherein W_{R} is calculated using Equation 2 presented hereinbelow.

It is noted herein that the entrapped liquid in the truly-closed-cell microstructure of the composition-of-matter presented herein, may be released from the encapsulating polymer under certain conditions. The release of the releasably entrapped liquid can be effected by compromising the integrity of the encapsulating polymeric walls. Once the encapsulating polymeric walls are fractured, broken, dissolved, degrade, decompose or otherwise lose their capacity as a physical barrier for the entrapped liquid, it is no longer entrapped. For example, the encapsulating polymeric walls may fracture upon applying, e.g., a compressive strain to the composition-of-matter, thereby releasing the entrapped liquid previously entrapped therein.

Alternatively, a truly-closed-cell microstructure may also release its entrapped content upon degradation of the polyHIPE under physiological, environmental and other external conditions, including solvent, enzymes, heat, pressure, radiation, sound waves, and the likes. One example of exploiting the capacity to release the entrapped liquid of the presently disclosed composition-of-matter, is for agricultural applications, wherein the entrapped liquid is a fertilizer, a pesticide, an herbicide and/or an irrigation liquid.

Oligomer, Monomers, Polymer, Copolymers:

In some embodiments of the present invention, the elastomer is formed primarily from the residues of monomers that confer elasticity in the resulting polymer, such as acrylic acid-based monomers, acrylate monomers, alkyl acrylate monomers, fluorinated and/or chlorinated acrylates, siloxane monomers, diene monomers, caprolactone oligomers, ethylene oxide oligomers and any oligomer or mixture thereof.

PolyHIPEs based upon monomers and oligomers that afford copolymers with glass transition temperatures (T_{g}s) below room temperature and with relatively low extents of crosslinking are highly elastomeric, and are characterized by a relatively low elastic modulus (E), as this term is known and used in the art. Without being bound by any particular theory, it is assumed that elasticity of the matrix is one of the factors that enables liquid retention, as the walls of the voids may sustain some degree of stress before breaking.

The term “elastomer” and its grammatical inflections, refer to a rubber-like stretchable and flexible polymeric substance, being capable of returning substantially to its original form once the deforming force effecting stress/strain has ceased. An elastomer is typically a polymer having a relatively low elastic modulus, which is sometimes referred to as the tensile modulus, Young's modulus or compressive modulus, depending on the approach of determination thereof.

The phrase “tensile modulus” refers to a physical quantity in solid mechanics, which is also known as the Young's modulus. It is a measure of the stiffness of an elastic substance, defined as the linear slope of a stress-versus-strain curve in uniaxial tension at low strains in which Hooke's Law is valid.

The phrase “compressive modulus” refers to a physical quantity in solid mechanics, which is theoretically equivalent to Young's Modulus determined from tensile experiments. It is a measure of the stiffness of an elastic substance, defined as the linear slope of a stress-versus-strain curve in uniaxial compression at low strains in which Hooke's Law is valid, hence it is the ratio of compressive stress to compressive strain below the proportional limit.

The tensile or compressive moduli, which are macroscopic properties of the composition-of-matter presented herein, can be determined experimentally from the slope of a stress-strain curve recorded during standard tensile or compression tests conducted on a sample of the composition-of-matter. In the context of embodiments of the present invention, the compressive modulus is not synonymous with the tensile modulus, the bulk modulus or the shear modulus of a substance, which refer to different elastic moduli.

In the context of embodiments of the present invention, the composition-of-matter comprises an elastomeric matrix, wherein its elasticity is defined by exhibiting a relatively low elastic modulus (E). A relatively low E is lower than 600 MPa, lower than 550 MPa, 500 MPa, 400 MPa, 300 MPa, 200 MPa, 100 MPa, 10 MPa, 5 MPa, 1 MPa, 500 kPa, 400 kPa, 300 kPa, 200 kPa, or lower than 100 kPa.

Crosslinked poly(2-ethylhexyl acrylate) (PEHA) is a highly elastomeric polymer. Previous work has demonstrated that EHA-based polyHIPEs, with no crosslinking comonomers, synthesized within Pickering emulsions and polymerized using interfacial initiation produced polyhedral, closed-cell structures. U.S. Pat. No. 9,062,245 provides compositions-of-matter, called LDE polyHIPEs, wherein the resulting elastomeric polyHIPE monoliths contained around 85% water in the form of individually encapsulated micrometer-scale droplet-containing voids. These liquid droplet elastomers (LDEs), were produced using one-pot syntheses. The specific combination of NP stabilization (instead of surfactant stabilization), NP crosslinking (instead of crosslinking via comonomers), interfacial free radical initiation (instead of organic-phase initiation) and a monomer that produces an elastomeric polymer were required to produce truly-closed-cell LDE polyHIPEs. These materials exhibit unique properties such as extraordinary water retention (even during long drying), a relatively large resistance to compressive deformation, and resistance to ignition upon direct exposure to a flame.

The present invention is a non-trivial expansion of the scope of building-blocks for LEDs, in the form of oligomers of elastic polymers; however, these substances, although beneficial to the objective of this expansion, present a challenge since at the relevant concentration conducive to polyHIPE formation, they are typically present as highly viscous liquids. The presence of highly viscous elements in a mixture of two immiscible liquids can hinder effective mixing, and thus, limit the relative amount of the highly viscous component. During the development of embodiments of the present invention, it was found that the smaller the difference between the viscosities of the two HIPE phases, the more stable the HIPE. This phenomenon has been seen in blends of polymer melts. For a major, low viscosity, aqueous phase, adding a solvent to the minor phase to reduce its viscosity is not always desirable since it may result in a negative impact on the polyHIPE's mechanical properties. Thus, it was suggested by the present inventors that for HIPEs containing viscous oligomers in the minor phase, a “thickener” may be added to the major phase to increase its viscosity. As demonstrated in the Examples section that follows below, one possible thickener is a polysaccharide such as alginate.

Thus, according to some embodiments of the present invention, the elastomeric matrix is a copolymer that is built from residues of at least one oligomer, serving as a comonomer in the copolymer.

In the context of embodiments of the present invention the tem “oligomer” refers to a molecule of intermediate relative molecular mass, the structure of which essentially comprises a small plurality of units derived, actually or conceptually, from molecules of lower relative molecular mass. According to the IUPAC definition, a molecule is regarded as having an intermediate relative molecular mass if it has properties which vary significantly with the removal of one or a few of the units. If a part or the whole of the molecule has an intermediate relative molecular mass and essentially comprises a small plurality of units derived, actually or conceptually, from molecules of lower relative molecular mass, it may be described as oligomeric, or by oligomer used adjectivally. Accordingly, the term “oligomerization”, as used herein, refers to the process of converting a plurality of monomers or a mixture of monomers into an oligomer.

According to embodiments of the present invention, the oligomers are reactive and crosslink the monomer. Alternatively, the oligomers are non-reactive and are located within the polymerized monomer, which may or may not be crosslinked, whereas this is equivalent to a semi-interpenetrating polymer network (polymer is crosslinked) or a blend (polymer not crosslinked). Further alternatively, the oligomers are reactive only with themselves and are located, whether non-crosslinked or crosslinked, within the polymerized monomer, which may or may not be crosslinked, whereas this is equivalent to an interpenetrating polymer network (both are crosslinked), a semi-interpenetrating polymer network (only one is crosslinked) or a blend (neither is crosslinked). Further alternatively, the organic phase comprises the oligomer dissolved in a solvent rather than in a monomer, and the dissolved oligomer becomes an elastomer upon removal of the solvent.

In the context of the present embodiments, an oligomer is a short polymer, having from 2-100 residues. Alternatively, in some embodiments, the oligomer is characterized by an average molecular weight that ranges from 100±10 g/mol to 10,000±1,000 g/mol. Alternatively, the oligomer is having an average molecular weight that ranges from 300±30 g/mol to 5,000±500 g/mol, or from 200±20 g/mol to 3,000±300 g/mol, or from 100±10 g/mol to 1,000±100 g/mol. In some embodiments, the oligomer is characterized by an average molecular weight of 100±50 g/mol, 200±50 g/mol 300±50 g/mol, 400±50 g/mol, 500±50 g/mol, 600±50 g/mol, 700±50 g/mol, 800±50 g/mol, 900±50 g/mol, 1000±50 g/mol, 1100±50 g/mol, 1200±50 g/mol, 1300±50 g/mol, 1400±50 g/mol, 1500±50 g/mol, 1600±50 g/mol, 1700±50 g/mol, or 1800±50 g/mol.

In some embodiments, the oligomer residue exhibits a plurality of reactive pendant functional groups which can take part in the polymerization process, thereby acting as crosslinking agents. In such embodiments, the oligomer contributes to the polymeric properties of the matrix as a main-chain comonomer and as a cros slinking comonomer. An exemplary reactive pendant functional group is, without limitation, a vinyl (double bond) group.

In the context of embodiments of the present invention, the term “oligomer” refers to reactive oligomers, thereby emphasizing that they can participate as reactive species in the polymerization reaction as comonomers and/or crosslinking agents.

Exemplary oligomers which can be used in the synthesis of the elastomeric matrix, according to embodiments of the present invention, include, without limitation, an oligomeric polybutadiene (PB), an oligomeric vinyl-terminated polydimethylsiloxane, an oligomeric polyisoprene, an oligomeric polychloroprene, an oligomeric nitrile rubber, an oligomeric diene rubber, an oligomeric butadiene-styrene rubber, an oligomeric ethylene-propylene rubber, an oligomeric ethylene-propylene-diene rubber, an oligomeric butyl rubber, an oligomeric polysulfide elastomer, an oligomeric polyurethane elastomer, an oligomeric thermoplastic elastomer, an oligomeric epichlorohydrin rubber, an oligomeric polyacrylic rubber, an oligomeric fluorosilicone rubber, an oligomeric fluoroelastomer, an oligomeric perfluoroelastomer, an oligomeric polyether block amides elastomer, an oligomeric chlorosulfonated polyethylene, an oligomeric ethylene-vinyl acetate elastomer, and any combination thereof.

It is noted herein that most diene oligomers (polybutadiene, polyisoprene, polychloroprene, nitrile rubber, diene rubber, butadiene-styrene rubber, ethylene-propylene-diene rubber, butyl rubber) have double bonds that can react (e.g., polybutadiene, polyisoprene, polychloroprene, nitrile rubber, diene rubber, butadiene-styrene rubber, ethylene-propylene-diene rubber, and butyl rubber). That said, the double bonds often need high temperatures to react (e.g., vulcanization). Some oligomers are essentially non-reactive and need terminal double bonds to become reactive with radical polymerization (e.g., ethylene-propylene rubber, polysulfide elastomer, polyurethane elastomer, thermoplastic elastomer, epichlorohydrin rubber, polyacrylic rubber, fluorosilicone rubber, fluoroelastomer, perfluoroelastomer, polyether block amides elastomer, chlorosulfonated polyethylene, and ethylene-vinyl acetate elastomer). The term “vinyl-terminated” is meant to encompass acrylate-terminated or methacrylate-terminated oligomers. An exception is 1,2-polybutadiene which usually comprises more than 80% pendent double bond per monomer, which makes it highly suitable in the context of some embodiments of the present invention. In the context of some embodiments, hydroxyl-terminated and carboxy-terminated, as well as amine-terminated and isocyanate-terminated oligomers can be readily modified to exhibit vinyl-terminated ends, and are therefore contemplated as suitable oligomers in the context of the present invention.

Polybutadiene, a particularly useful oligomer in the context of some embodiments of the present invention, is commercially available in a range of molecular species, ranging from 900 g/mol and 5 poise to 3200 g/mol and 450 poise.

Additional optional oligomers include, for a non-limiting example, polyisoprene (PI) oligomers (either 1,2-PI or hydroxy-terminated PI which can become vinyl-terminated), polychloroprene oligomers, nitrile rubber oligomers, ethylene-propylene rubber oligomers with terminal reactive groups, ethylene-propylene rubber (EPR) oligomers, ethylene-propylene-diene-monomer (EPDM) rubber oligomers, and the likes. For clarity it is noted that a “butadiene oligomer” is actually a polybutadiene oligomer, since butadiene is the monomer. The same comment is relevant for other oligomers, and it such cases it is referred to as butadiene-based oligomers, isoprene-based oligomers, etc., since that would encompass all possible copolymers comprising such monomers/oligomers.

The elastomeric matrix also includes residues of monomers, which react with the oligomers to form the copolymer. In some embodiments, the monomers are selected such that each is forming a homopolymer having a T_{g} lower than 30±5° C. Alternatively, the monomers are selected such that each is forming a homopolymer having an elastic modulus of less than 600±60 MPa. Each of these properties contributes to the elasticity of the matrix, and hence to the water retention (W_{R}) property thereof.

In some embodiments, the monomers and their quantities are selected such that their combination forms a copolymer having a T_{g} lower than 30±5° C. Alternatively, the monomers and their quantities are selected such that their combination forms a homopolymer having an elastic modulus of less than 600±60 MPa. Each of these properties contributes to the elasticity of the matrix, and hence to the water retention (w_{R}) property thereof. For example, it is known in the art that adding some methyl methacrylate to EHA can still afford an elastomer.

Families of monomers that are highly suitable for synthesis of the matrix of the present invention include, without limitation, acrylates, methacrylates, dienes, vinyl esters, vinylidenes, lactams, lactones, cyclic ethers, epoxides, di-carboxylic acids, di-acylhalides, diamines, di-amides, di-esters, diketones, amino-acids, polyols, and combinations thereof. In some embodiments, the monomers are acrylate monomers, methacrylate monomers and/or diene monomers.

Exemplary monomers which can be used in the synthesis of the elastomeric matrix, according to embodiments of the present invention, include, without limitation, 2-ethylhexyl acrylate (EHA), n-butyl acrylate (nBA), ethyl acrylate (EA), methyl acrylate (MA), hexyl acrylate (HA), lauryl acrylate, lauryl methacrylate, stearyl methacrylate, 2-[[(butylamino)carbonyl]oxy]ethyl acrylate, and any combination thereof.

Additionally, monomers suitable for use in the formation of the elastomer, include, without limitation, methyl acrylate, ethyl acrylate, phenoxyethyl acrylate, propyl acrylate, butyl acrylate, 2-ethylhexyl acrylate, glycidyl acrylate, ethylene glycol diacrylate, diethylene glycol diacrylate, 1,6-hexanediol diacrylate, trimethylolpropane triacrylate, pentaerythritol triacrylate, pentaerythritol tetraacrylate, methyl methacrylate, ethyl methacrylate, dimethylaminoethyl methacrylate, propyl methacrylate, butyl methacrylate, 2-ethylhexyl methacrylate, glycidyl methacrylate, ethylene glycol dimethacrylate, diethylene glycol dimethacrylate, triethylene glycol dimethacrylate, tetraethylene glycol dimethacrylate, trimethylolpropane trimethacrylate, bisphenol A dimethacrylate, and mixtures thereof.

Exemplary acrylate monomers include, without limitation, methyl acrylate, ethyl acrylate, propyl acrylate, butyl acrylate, isobutyl acrylate, tert-butyl acrylate, 2-ethylhexyl acrylate, hexyl acrylate, octyl acrylate, isooctyl acrylate, decyl acrylate, isodecyl acrylate, lauryl acrylate, stearyl acrylate, behenyl acrylate, 3,5,5-trimethylhexyl acrylate, 2-chloroethyl acrylate, isobornyl acrylate, tetrahydrofurfuryl acrylate, 4-tert-butylcyclohexyl acrylate, 2-phenoxyethyl acrylate, trimethylsilyl acrylate, pentabromobenzyl acrylate, 2,2,2-trifluoroethyl acrylate 2,2,3,3,3-pentafluoropropyl acrylate, 1,1,1,3,3,3-hexafluoroisopropyl acrylate, 2,2,3,4,4,4-hexafluorobutyl acrylate, 2,2,3,3,4,4,4-heptafluorobutyl acrylate, 2,2,3,3,4,4,5,5,6,6,7,7-dodecafluoroheptyl acrylate, 3,3,4,4,5,5,6,6,7,7,8,8,8-tridecafluorooctyl acrylate, pentafluorophenyl acrylate, and any mixtures thereof.

Exemplary methacrylate monomers include, without limitation, methyl methacrylate, ethyl methacrylate, propyl methacrylate, butyl methacrylate, isobutyl methacrylate, tert-butyl methacrylate, sec-butyl methacrylate, 2-ethylhexyl methacrylate, hexyl methacrylate, cyclohexyl methacrylate, isodecyl methacrylate, lauryl methacrylate, stearyl methacrylate, isobornyl methacrylate, furfuryl methacrylate, tetrahydrofurfuryl methacrylate, 2-ethoxyethyl methacrylate, (trimethylsilyl)methacrylate, benzyl methacrylate, phenyl methacrylate, glycidyl methacrylate, poly(ethylene glycol) methacrylate, 3,3,5-trimethylcyclohexyl methacrylate, 2,2,2-trifluoroethyl methacrylate, 2,2,3,3-tetrafluoropropyl methacrylate, 2,2,3,3,3-pentafluoropropyl methacrylate, 1,1,1,3,3,3-hexafluoroisopropyl methacrylate, 2,2,3 ,4,4,4-hexafluorobutyl methacrylate, 2,2,3,3,4,4,4-heptafluorobutyl methacrylate, 2,2,3,3,4,4,5,5-octafluoropentyl methacrylate, 3,3,4,4,5,5,6,6,7,7,8,8,8-tridecafluorooctyl methacrylate, 3,3,4,4,5,5,6,6,7,7,8,8,9,9,10,10,10-heptadecafluorodecyl methacrylate, 2,4,6-tribromophenyl methacrylate, pentafluorophenyl methacrylate, pentabromobenzyl methacrylate, and mixtures thereof.

Exemplary diene monomers include, without limitation, 1,3-butadiene and oligomers thereof, 2-methyl-1,3-butadiene and oligomers thereof, 2-chlorobuta-1,3-diene and oligomers thereof, a polybutadiene oligomer and any combination thereof.

Exemplary siloxane monomers include, without limitation, dimethylsiloxane and oligomers thereof, a polydimethylsiloxane oligomer and any combination thereof.

In some embodiments, the elastomer is selected from the group consisting of a rubber, natural polyisoprene such as cis-1,4-polyisoprene natural rubber (NR) and trans-1,4-polyisoprene gutta-percha, synthetic polyisoprene (isoprene rubber), polybutadiene (butadiene rubber), chloroprene rubber, polychloroprene, neoprene, baypren, butyl rubber (copolymer of isobutylene and isoprene), halogenated butyl rubbers (chloro- and bromo-butyl rubber), styrene-butadiene rubber (copolymer of styrene and butadiene), nitrile rubber (copolymer of butadiene and acrylonitrile), hydrogenated nitrile rubbers (therban and zetpol), ethylene propylene rubber (a copolymer of ethylene and propylene), ethylene propylene diene rubber (a terpolymer of ethylene, propylene and a diene-component), epichlorohydrin rubber, polyacrylic rubber, silicone rubber, fluorosilicone rubber, fluoroelastomers, viton, tecnoflon, fluorel, aflas and dai-el, perfluoroelastomers, tecnoflon PFR, kalrez, chemraz, perlast, polyether block amides, chlorosulfonated polyethylene (Hypalon), ethylene-vinyl acetate, polysulfide rubber and elastolefins. It is noted herein that fully hydrogenated rubbers have few reactive double bonds remaining for reactivity and crosslinking. Thus, in the context of some embodiments of the present invention, partially hydrogenated rubbers are preferable since these contain some reactive double bonds.

The mixture of all monomers and oligomers constituting the polymerizable organic external phase of the HIPE, also referred to herein as the pre-polymerization mixture, may also be characterized by forming a monolithic bulk copolymer having a T_{g} lower than 30±5° C. and/or having an elastic modulus of less than 600±60 MPa. The copolymer constituting the elastomeric matrix comprises residues of oligomers and monomers at a ratio that ranges from 10:90 to 90:10, and any ratio value therebetween.

Non-Homogeneous Crosslinking Level:

A crosslinking agent is typically characterized according to its capacity to alter the elasticity/rigidity balance of a polymeric composition. Thus, a crosslinking agent (or moiety) is a component having an effect on the flexibility of the obtained polymer, giving it the desired mechanical properties. Crosslinks bond one polymer chain to another by covalent bonds, coordinative bonds or ionic bonds. When the term “crosslinking” is used in the synthetic polymer science field, it usually refers to the use of crosslinks to promote a difference in the polymer's physical properties.

As used herein, the phrases “crosslinking agent” refers to a substance that promotes or regulates intermolecular covalent, ionic, hydrophobic or other form of bonding between polymer chains, linking them together to create a network of chains which result in a more rigid structure. Crosslinking agents, monomers or oligomers, having a plurality of polymerizable moieties attached thereon, according to some embodiments of the present invention, contain a functionality greater than two, for example, two double bonds (vinyls) (a functionality of four) or three amines (a functionality of three), creating chemical bonds between two or more polymer molecules (chains).

Most polyHIPEs are crosslinked using crosslinking comonomers such as divinylbenzene (DVB) for w/o HIPEs and N,N′-methylenebisacrylamide (MBAM) for o/w HIPEs. A crosslinking comonomer, in the abovementioned example of radical polymerization, is a molecule with at least two polymerizable double bonds. The most common crosslinking comonomers contain two polymerizable double bonds. However, it is also possible to crosslink polyHIPEs using comonomers or oligomers containing multiple polymerizable double bonds, or other reactive functional groups in other polymerization mechanisms, such as carboxyls, ethers, cyanates, amines, amides, sulfones, sulfates, thiols, hydroxyls and the likes.

As presented in U.S. Pat. No. 9,062,245 and elsewhere, stabilizing NPs bearing polymerizable double bonds can also function as crosslinking centers (hubs). The silane functionality can contain such bonds. The crosslinking using NPs enhanced the elastomeric behavior compared to crosslinking using DVB; since the Pickering HIPE NPs are located at the oil-water interface before polymerization, it has been expected that they will be found on the void surfaces in the polyHIPE (the phase interface), rather than in the bulk of the polymer (not necessarily at or near the phase interface); however, the NPs ended up being within the walls, pushed from the interface by monomer diffusion, and not on the void surface. The elastomeric nature was probably enhanced since there were significantly less crosslinking sites than exist when using DVB.

In embodiments of the present invention the polyHIPE is synthesized using an oligomer as a crosslinking agent, and the polymerization initiation is effected by an initiator that is water soluble, namely it is present exclusively in the aqueous internal phase, and thus can come in contact and effect polymerization in the organic external phase, including crosslinking between the oligomer's pendent groups, only at the phase interface; therefore, crosslinking is effected at the matrix-liquid interface and substantially not at the bulk of the matrix, whereas the term “bulk” refers to regions in the matrix not necessarily at or near the phase interface or matrix-liquid interface, or away from the matrix-liquid interface. This definition is referring to a non-homogeneity of the crosslinking level throughout the matrix.

According to some embodiments of the present invention, the elastomeric matrix is characterized by being crosslinked primarily at or near the matrix-liquid interface, namely the crosslinking level at a matrix-liquid interface is higher relative to the crosslinking level in a bulk thereof. According to some embodiments of the present invention, the elastomeric matrix is characterized by a crosslinking level of at a matrix-liquid interface higher relative to a crosslinking level in a bulk thereof. The term “crosslinking level” refers to the number of crosslinks per unit of length of the main-chain of the copolymer constituting the elastomeric matrix, and the definition can be seen as quantitative or relative-qualitative comparing two regions in the copolymer, one being the vicinity of the matrix-liquid interface, and the other being the bulk of the copolymer, not necessarily at or near the matrix-liquid interface, or away from the matrix-liquid interface.

Without being bound by any particular theory, it is assumed that the results presented hereinbelow indicated that the crosslinking level in the interfacially initiated polyHIPEs is lower than it is in the organic-phase initiated polyHIPEs since the monomer is somewhat surface active and its concentration at the interface is expected to be higher than that of the polybutadiene. However, it is assumed that in the final interfacially initiated polyHIPE there is a gradient in the crosslinking level across the wall starting at high level from the interface and going into the bulk, which is different from the gradient exhibited in the organic-phase initiated polyHIPE, which is uniform across the wall's thickness regardless of the proximity to the interface. Alternatively, it is assumed that the extent of crosslinking from organic-phase initiation is higher compared to the crosslinking level that results from interfacial initiation. It is noted that the gradient for crosslinking level using interfacial initiation may even be the opposite since the environment at the interface may be monomer-rich and oligomer-poor. Hence, it is assumed that in the final interfacially initiated polyHIPE there is a non-homogeneity in the crosslinking level across the wall.

In the context of the present embodiments, the location and nature of the crosslinking agent also confers the formation of a truly-closed-cell versus open-cell microstructure. In the context of the crosslinking function, a crosslinking moiety in the context of a monomer or an oligomer, is equivalent to a crosslinking agent.

Collectively, monomers and oligomers useful as polymerizable moieties according to some embodiments of the present invention, may be represented as being a monomer or oligomer containing a vinyl group (e.g., ethylene, propylene, vinyl chloride, vinyl acetate, acrylates, methacrylates, styrenes, dienes) or a vinylidene group having the structural formula CH₂═C<where at least one of the disconnected valences is attached to an electronegative radical such as phenyl, acetoxy, carboxy, carbonitrile and halogen, examples of the monomers being those hereinbefore listed as well as styrene, vinylnaphthalene, alphamethylstyrene, dichlorostyrenes, alpha-methylene carboxylic acids, their esters, nitriles and amides including acrylic acid, acrylonitrile, acrylamide; the vinyl esters of alkanoic acids including vinyl formate, vinyl acetate, vinyl propionate, vinyl butyrate, vinyl pyridine; the alkyl vinyl ketones including methyl vinyl ketone; the conjugated diolefines including 1,3-butadiene; isoprene chloroprene, piperylene and 2,3-dimethyl-1,3-butadiene (CH₂═C(CH₃)C(CH₃)═CH₂).

Additional monomers and oligomers useful as polymerizable moieties, according to some embodiments of the present invention, include, without limitation, ring-opening monomers and oligomers such as lactams, lactones, cyclic ethers and epoxides; condensation monomers such as di-carboxylic acids, di-acylhalides, diamines, di-amides, di-esters, diketones, amino-acids, polyols and the likes.

Emulsion Stabilizers:

As discussed herein throughout, the matrix is a polyHIPE, which is the product of polymerization effected in the external phase of a HIPE, and thus the matrix is characterized by having a microstructure structurally-templated by the external phase of the HIPE, and the voids in the matrix are the residue of droplets of the internal phase of the HIPE, such that the elastomeric matrix entraps the liquid in these voids. The biphasic structure of HIPEs can be maintained during polymerization under the right conditions using emulsion stabilizers.

In some embodiments of the present invention, the HIPE is a water-in-oil (w/o) HIPE. HIPEs are highly viscous, paste-like emulsions in which the dispersed, internal phase constitutes more than 74% of the volume. HIPEs are inherently unstable and have a tendency to undergo phase inversion or phase coalescence. The HIPE structure, which is analogous to a conventional gas-liquid foam of low liquid content, gives rise to a number of properties including high viscosities and viscoelastic rheological behavior. Like dilute emulsions, HIPEs are intrinsically unstable; nevertheless, it is possible to prepare metastable systems which show no change in properties or appearance over long periods of time.

Only a few of the available emulsion stabilizers (emulsifiers) are able to keep the major internal phase dispersed within the minor external phase. Such an emulsifier is typically insoluble in the internal phase and its molecular packing is capable of promoting the formation of a convex interface between the external and internal phases. If the internal phase, external phase, or both phases contain monomers then a polymer can be synthesized within the HIPE. As discussed hereinabove, one of the challenges in forming a polyHIPE is stabilizing the precursor HIPE though the polymerization reaction. Typically a HIPE is stabilized by a surface active agent, generally referred to herein as an emulsion stabilizer. In the context of embodiments of the present invention, suitable emulsion stabilizers include surfactants and/or certain types of block copolymers (reactive and/or non-reactive), and/or solid particles. In some embodiments, the effect of the abovementioned emulsion stabilizers is further enhanced by salts.

In the context of the present invention, the composition-of-matter presented herein is unique in that it is a product of a polymerization of a HIPE that is not stabilized with HIPE-stabilizing particles or nanoparticles (NP), as described, for example, in U.S. Pat. No. 9,062,245, yet it exhibits a truly—closed—cell microstructure. Hence, the composition-of-matter presented herein is substantially devoid of HIPE-stabilizing particles.

According to some embodiments of the present invention, the emulsion stabilizer is a surfactant that is not a nanoparticle, which is present in the external organic phase of the precursor HIPE. Alternatively, in some embodiments, the surfactant is present in the internal and/or the external phase of the precursor HIPE. The surfactant is characterized, inter alia, by its hydrophilic-lipophilic balance (HLB). The hydrophilic-lipophilic balance of a surfactant is a measure of the degree to which it is hydrophilic or lipophilic, determined by calculating values for the different regions of the molecule. HLB values can be used to roughly predict the surfactant properties of a molecule, wherein HLB<10 is exhibited by a lipid-soluble (water-insoluble) surfactant, HLB>10 by water-soluble (lipid-insoluble) surfactant, 1 to 3 is an HLB of an anti-foaming agent, 3 to 8 is an HLB of a W/O (water in oil) emulsifier, 7 to 9 is an HLB of a wetting and spreading agent, 13 to 16 is an HLB of a detergent, 8 to 16 is an HLB of an O/W (oil in water) emulsifier, and 16 to 18 is an HLB of a solubilizer or hydrotrope. The surfactant used for stabilizing the precursor HIPE, en route to forming the composition-of-matter provided herein, is characterized, according to some embodiments of the present invention, by an HLB that ranges from 3 to 6.

Exemplary hydrophobic non-ionic surfactants include, without limitation, poloxamers, members of the alkylphenol hydroxypolyethylene family and a polyethoxylated sorbitan esters (polysorbitans). Other types of surfactants, such as anionic and cationic surfactants are also contemplated within the scope of the present invention. According to some embodiments of the present invention, the surfactant is nonionic surfactant.

In some embodiments, the surfactant is suitable for stabilizing water-in-oil HIPEs, such as members of the Span family of surfactants (such as sorbitan monooleate (SMO), sorbitan monolaurate (SML)), polyglycerol polyricinoleate (PGPR), and the Hypermer family of surfactants. In some embodiments, the surfactant is selected from the group consisting of sorbitan monooleate, polyglycerol polyricinoleate, a hydrophobic-hydrophilic block copolymer, and any combination thereof.

The concentration of the emulsion stabilizing surfactant ranges, according to some embodiments of the present invention, from 0.01% to 30% by weight of the total weight of the organic external phase of the precursor HIPE.

Alternatively, the surfactant is suitable for stabilizing oil-in-water HIPEs, such as members of the Tween family of surfactants, the Triton family of surfactants, sodium lauryl sulfate (SLS), sodium dodecyl sulfate (SDS), and, in addition block copolymers such as PEO-PPO-PEO and the likes.

Alternatively, the surfactant is a member of the commercially available Pluronic® type surfactant, all of which are block copolymers based on poly(ethylene oxide) (PEO) and poly(propylene oxide) (PPO). Pluronics can function as antifoaming agents, wetting agents, dispersants, thickeners, and emulsifiers.

Alternatively, the surfactant is an oil-soluble member of the commercially available Synperonic™ PE family of surfactants, constituting non-ionic, tri-block copolymer surfactants suitable for industrial and pharmaceutical applications. These poloxamers are chemically very similar, differing only in their poly(propylene oxide) to poly(ethylene oxide) content. This variation causes the physical and surface active properties of the poloxamers to vary.

Alternatively, the surfactant is an oil-soluble member of the commercially available Kolliphor™ type surfactant.

Additional information regarding emulsion stabilizing solid particles can be found in the art [Silverstein, M. S., Polymer, 2014, 55, pp. 304-320; and Silverstein, M. S. and Cameron, N. R., PolyHIPEs—Porous Polymers from High Internal Phase Emulsions, Encyclopedia of Polymer Science and Technology, 2010].

Locus of Initiation:

Without being bound by any particular theory, it was hypothesized by the present inventors that in order to arrive at a truly-closed-cell polyHIPE that can retain the liquid part of the emulsion entrapped inside the voids in the matrix, the polymerizable external phase should be polymerized first at the interface between the external and the internal phases (herein throughout the “phase interface”, the “matrix-liquid interface”, or the “interface”), affording intact walls that engulf the internal phase droplets entirely. It was further hypothesized that two factors contribute to the formation of intact elastomeric walls, locus of initiation of polymerization (hereinafter “initiation”), and locus of the crosslinking as discussed herein. It is noted that in previous work using NPs modified to exhibit polymerization initiator as well as crosslinking moieties thereon, “locus of initiation” was critical to the formation of the truly-closed-cell microstructure; the “locus of crosslinking” was on the NP surfaces seemed to produce a lower crosslink density (crosslinking level) at and/or near the interface, leading to a more elastomeric polymer; that is to say that the location of the NPs caused non-homogeneity in the crosslinking throughout the wall cross-section.

The two most common polymerization mechanisms are free radical polymerization (FRP) and step-growth polymerization (SGP). Conventional free radical polymerization, named also chain-growth polymerization, is the most common mechanism for polymerization within HIPE systems. Typically, an initiator is needed for FRP, and typically, but not exclusively, the monomer should contain a polymerizable double bond. FRP initiators for polyHIPE synthesis in w/o HIPEs can be either water-soluble or oil-soluble. The use of a water-soluble initiator produces interfacial initiation since the monomer and the initiator are located in different phases and can come in reaction-enabling contact only at the phase interface. The use of an oil-soluble initiator produces organic phase initiation, where the monomer and initiator are in the same phase, throughout the bulk of the polymerizable phase. The locus of initiation has a profound effect on the polyHIPE macromolecular structure, porous structure, and properties. PolyHIPEs which have been polymerized using an aqueous-soluble polymerization initiator that can thus be present only in the internal phase, have been shown herein to afford truly-closed-cell microstructures, contrary to polyHIPEs which have been produced using an organic-soluble polymerization initiator. A water-soluble polymerization initiator is capable of effecting interfacial initiation, and polymerization using interfacial initiation begins at the phase interface and “locks in” the HIPE's polyhedral droplet shape before any destabilization through droplet coalescence and/or Ostwald ripening can occur.

Thus, according to some embodiments of the present invention, the internal phase includes a polymerization initiator, and the polymerization initiator is water-soluble and substantially organic-immiscible. Exemplary water-soluble free-radical polymerization initiators include, without limitation, potassium persulfate (KPS), ammonium persulfate (APS) and 4,4-azobis(4-cyanovaleric acid).

As discussed in the Example section hereinbelow, inspecting cryogenic fracture surfaces in SEM micrographs reveled that KPS-initiated polyHIPEs (phase interface initiation) had smooth, non-porous surfaces (demonstrated water retentions (W_{R}) of 45% and 77%) which indicate more elastomeric walls that collapse and fill in the holes when the sample is fractured and the water evaporates. The organic-soluble BPO-initiated polyHIPEs exhibited no water retention (w_{R} of 0) and rough, porous surfaces, which indicate walls that did not collapse to the same extent when the sample is fractured and the water evaporates.

It is noted herein that the invention is not limited to the use of one particular polymerization mechanism, and hence also not limited to any particular initiation mechanism or crosslinking mechanism. A variety of polymerization mechanisms including, but not limited to, chain-growth polymerization (free radical, controlled free radical, anionic, cationic and the like) and step-growth polymerization (condensation and addition and the like), ring opening polymerization, and others, which afford an elastic polyHIPE devoid of emulsion-stabilizing particles/NPs and exhibiting a truly-closed-cell microstructure, are also encompassed and contemplated according to embodiments of the invention presented herein. For example, a photoinitiator can be used, and a light/radiation activated initiator can be dispersed or dissolved in the aqueous internal phase. For another example, an LDE can be formed from a HIPE which is based on polymer solutions in which evaporation of one or more constituents of the solution (e.g., solvent) is used to produce the final composition of matter, such that the solidification process is effected by loss or reduction in quantity of one or more volatile component from the HIPE.

Other reagents that can afford LDEs, according to some embodiments of the present invention, are also contemplated, including other multi-functional reagents that can serve as emulsion stabilizers and at the same time serve as crosslinking hubs, and other reagents that will have the additional function of serving as an initiation center. Such multi-functional reagents are not required to be in a form of nanoparticles, as some specially designed molecule can be synthesized to have all the aforementioned functionalities, namely a surfactant that can initiate and/or crosslink polymerization reactions at the interface of the internal and external phases in a HIPE.

The internal aqueous phase may further include, according to some embodiments of the present invention, a stabilizing salt, such as, for example, K₂SO₄ or NaCl.

Relative Viscosity of HIPE-Phases:

As discussed hereinabove, the stability of the precursor HIPE necessitated closing the gap in the viscosities of the two phases, namely bringing the ratio of the viscosities of the internal phase and the external phase closer to one. While the more commonly used methodology of stabilizing emulsions of two phases exhibiting a higher viscosity in the organic phase is thinning the organic phase with solvents, diluting the external organic phase was found impractical in the case of the presently disclosed HIPE systems, but the counterintuitive thickening of the aqueous internal phase was surprisingly found advantageous regardless of the fact that it increased the viscosity of an already viscous HIPE.

It was found that while thinning of the external organic phase is rather limited in terms of the resulting polyHIPE, the thickening of the internal phase can be afforded by a number of approaches. It was found that when the external phase is drastically thicker (more viscous) than the internal phase, any substance that is sufficiently thick and liquid at the HIPE-preparing temperature, and is immiscible in the organic phase, can be used effectively in to production of the composition-of-matter presented herein.

Thus, according to some embodiments, the internal aqueous phase, which is the precursor of the liquid entrapped by the matrix in the composition-of-matter, and essentially identical thereto, further comprises a thickening agent. The thickening agent is required to modify the rheology of the internal phase, or entrapped liquid, therefore it can be selected from a relatively broad range of thickeners, natural or synthetic, organic or inorganic, polysaccharide-based or protein-based, and the likes. In some embodiments, the internal phase is intrinsically a thick viscous liquid at the temperature of HIPE preparation.

In some embodiments, a thickening agent in added to an aqueous solution constituting the internal phase, and the thickening agent is selected from the group consisting of a polysaccharide or carbohydrate, such as alginate (alginic acid), agar, carrageenan, locust bean gum, a vegetable gum and pectin, as well as a polyethylene glycol, a polyacrylic acid, a carbomer, a polyurethane, latex, styrene/butadiene, polyvinyl alcohol, cassein, gelatin, collagen, albumin, modified castor oil, an organosilicone, and any combination thereof. In some embodiments, the polysaccharide is alginate.

According to some embodiments, the ratio of viscosity of the organic phase (Vor_{g}) to the viscosity of the aqueous phase (V_{aq}) is brought closer to one (V_{org}/V_{aq}→1). This feat can be achieved by adding a thickening agent to the internal aqueous phase and/or by adding a low-viscosity monomer and/or a solvent to the external organic phase. Keeping in mind that the viscosity of water is 1 cp and the viscosity of a typical oligomer is about 10,000 cp, a typical V_{org}/V_{aq} may cover a vast range of values. Thus, according to some embodiments of the present invention, the ratio V_{org}/V_{aq} ranges from 1,000 to 0.001, or 100-0.01, or 10-0.1, or ranges from 1.1-0.9.

According to some embodiments, the concentration of the thickening agent is selected such that the thickening agent modifies the aqueous phase (the liquid) to exhibit a viscosity that ranges from 10 cp to 10,000 cp, or any intermediate viscosity value.

Elastomer Additives:

The pre-polymerized mixture (the polymerizable external phase of the HIPE) may further comprise additional optional ingredients (additives) that confer specific properties to the resulting matrix after the polyHIPE is afforded, such as colorants and the likes.

It is noted herein that an additive can also be dispersed rather than dissolved in the organic phase; hence, an additive can be a solid or an immiscible liquid that is emulsified, dispersed and/or suspended and is uniformly dispersed in the organic phase.

For example, the external phase may include reinforcing agents, conducting agents, magnetic agents, curing agents, cure accelerators, catalysts, tackifiers, plasticizers, flame retardants, flow control agents, fillers, organic and inorganic microspheres, organic and inorganic microparticles, organic and inorganic nanoparticles, electrically conductive particles, thermally conductive particles, fibers, antistatic agents, antioxidants, anticorrosion agents, UV absorbers, colorants and other typical additives which add beneficial properties to the finished elastomer.

According to some embodiments, the entrapped liquid is an inherent residual of the predecessor internal phase in the HIPE used in the process, from which the composition-of-matter is derived. In other words, the external phase polymerized to form a continuous elastomeric matrix, as this phrase is defined hereinbelow, and the internal phase has been entrapped in the matrix in the form of liquid-entrapping cells, as this phrase is defined herein-throughout. Once the polymerization process is complete, the internal phase is entrapped in the polymerized external phase in the form of a plurality of closed cells or droplets. The liquid part of the afforded composition-of-matter, according to some embodiments of the present invention, can be any aqueous solution of one or more water-soluble additive, and/or a suspension/dispersion of one or more additives, and/or an emulation of one or more additive, which may contain one of more minor or major solutes, which are entrapped as well in the cells dispersed in the elastomer, as discussed herein.

It is noted herein that an additive can also be dispersed rather than dissolved; hence, an additive can be a solid or an immiscible liquid that is wetted or engulfed by water in the aqueous phase and is uniformly dispersed substantially without forming agglomerates, floating or forming a sediment.

In some embodiments, the pre-polymerized mixture (the polymerizable external phase of the HIPE) may further comprise a labile agent as an additive, which confers lability properties to the resulting matrix after the polyHIPE is afforded, as discussed hereinbelow.

Labile Elastomer:

The elastomeric matrix of the composition-of-matter presented herein, according to some embodiments of the present invention, is degradable or biodegradable, jointly referred to herein as “labile”, making the composition-of-matter more environmentally friendly. In some embodiments, the elastomer is degradable by, but not limited to, spontaneous bond cleavage (e.g., spontaneous bond hydrolysis), degradation by exposure to ambient conditions (humidity, oxidation, UV radiation, heat etc.), chemical degradation effected by a chemical found in the environment or in the encapsulated substance, enzymatic degradation conferred by microorganisms in the environment, and any polymer degradation mechanism known in the art. Degradability can be achieved by cleaving bonds in the main chain of the polymer/elastomer, by cleaving crosslinking bonds, or by a combination thereof.

Degradability of the elastomer can be achieved by using a liable elastomer, or by using labile units as part of the external phase of the HIPE, such that these labile units are incorporated into the elastomer during the polymerization process to afford an elastic labile co-polymer. Such labile units include labile monomers, labile oligomers, labile crosslinking agents, block copolymers with a labile block and graft copolymers with a labile graft. For example, monomers containing disulfide bonds can undergo degradation and are therefore considered as labile monomers, and an oligomer comprising the same is a labile oligomer.

Degradable polymers and oligomers include, but are not limited to, polylactic acid (PLA), polyglycolic acid (PGA), poly(lactic-co-glycolic acid) (PLGA), polycaprolactone (PCL), polyorthoesters, polydioxanones, polyanhydrides, poly(trimethylene carbonates), polyphosphazenes and the likes. The incorporation of at least some labile monomers, labile oligomers and/or labile crosslinking agents, into the pre-polymerization mixture, requires adjustment of the monomer composition so as to afford an elastomer with the required modulus, which is within the skills of an expert in the field of polymer synthesis.

In some embodiments, the pre-polymerization mixture, which constitutes the external phase of the HIPE, is formulated to include an additive that renders the resulting elastomer labile without becoming a part of the main-chain, a side-chain or a crosslink of the polymer. These additives, or polymer-degradation inducing agents, typically based on metal ions such as Fe, Co, Mn, Ce, Cu and Ni, or organic acid salts such as benzoates, hexanoates, octanoates and napthenates, form weak links in a polymer chain that oxidize to render the polymer unstable and labile through exposure to light and oxygen (photodegradable; oxydegradable). A person skilled in the art would find ample guidance to the formation of labile polymers, for example in U.S. Pat. Nos. 4,056,499, 5,681,873, 5,874,486, 6,277,899, 7,037,983, 7,812,066, 7,816,424, 8,222,316 and 8,513,329.

In some embodiments, the crosslinking agent is used to confer degradability (lability) to the polyHIPE, namely the crosslinking agent introduces chemical functionalities to the elastomer that can cause the elastomer to degrade and break down under ambient conditions. Crosslinking agents which are known for use in crosslinking of degradable (labile) polymers include formaldehyde, glutaraldehyde, dialdehyde starches, epoxides, carbodiimides, isocyanates, metallic crosslinking agents, ionic crosslinking agents, heterocyclic compounds, acrylic derivatives, vinyl-terminated oligomers, acryl-terminated oligomers, and mixtures thereof.

In embodiments using degradable (labile) crosslinking agents in the bulk of the elastomer, the substance-releasing profile is influenced by the presence of bulk crosslinks and by the rate of crosslinking breakdown, both affecting, albeit at different rates, the closedness of the cells in the elastomer as well as the permeability of the elastomer to the encapsulated substance.

According to some embodiments, degradable crosslinking agents suitable in the context of the present invention, include any compound with at least two polymerizable functionalities that can partake in the formation of a polymer, and can undergo a cleavage reaction under ambient or specific conditions, thereby breaking the crosslinks in the polymer. Exemplary degradable (labile) crosslinking agents include, but are not limited to, methacrylate-terminated polycaprolactone oligomers, methacrylate-terminated polylactide oligomers, methacrylate-terminated polyglycolide oligomers, methacrylate-terminated poly(lactide-co-glycolide) oligomers. It is noted herein that the term “methacrylate-terminated” indicates the presence of at least two methacrylate groups, one at each end of the original diol oligomer, therefore a “methacrylate-terminated” oligomer is a crosslinker of a polymer.

### Substance-Releasing System:

According to some embodiments of the present invention, the additive in the aqueous phase is releasable, such that the entrapped liquid comprises at least one releasable substance, and the composition-of-matter provided herein is a substance-releasing system.

A typical substance-releasing system, also referred to herein interchangeably as a substance release system and a sustained release system, relevant in the context of the present embodiments, comprises a reservoir containing a predetermined and exhaustible amount of the releasable substance, and an interface between the substance's reservoir and the surrounding environment that the system is placed within. Typically, substance release commences at the initial time point when the system is exposed to the environment, and in some embodiments follows typical diffusion-controlled kinetics. In the context of embodiments of the present invention, the (dissolved or suspended) solids, which are releasably entrapped/encapsulated in the elastomer, are releasable through the elastomer when the composition-of-matter is exposed to an aqueous environment.

In some applications it is desirable to deliver a large amount of a substance at a relatively short period of time, however, for most substance-releasing applications, the initial burst stage releases more substance than is necessary (and in some cases more than optimal, e.g., at a harmful level) while depleting the reservoir from the substance, leading to premature shortening of the delivery period. Such problems are common to most substance-releasing systems wherein the substance is in direct contact with the environment, as in substance-releasing systems based on polymeric foams which tend to deploy their content, namely the substance, too rapidly.

In the context of embodiments of the present invention, the composition-of-matter presented herein serves as an effective substance-releasing system, since the interface between the substance's reservoir and the environment is essentially not a direct contact but rather a polymer/elastomer (a typically thin polymeric membrane in the form of a polyHIPE wall) which can be designed to exhibit pre-determined substance-release profile that is characterized by the presence of a minimal burst release, or lack of an initial burst release, and characterized by the duration of a sustained release.

A “substance-release profile” is a general expression which describes the temporal concentration of a substance (e.g., a solute) as measured in the environment or medium in which the system is present as a function of time, while the slope of a concentration versus time represents the rate of release at any given time point or range. A substance-release profile may be sectioned into rate dependent periods, or phases, whereby the rate is rising or declining linearly or exponentially, or staying substantially constant. Some of the most commonly referred to rates include burst release and sustained release.

The release rate known as “burst release”, as used herein, is consistent with a rapid release of the substance into the bodily site of interest, and is typically associated with an exponential increase of the substance's concentration, growing exponentially from zero to a high level at a relatively short time. Typically, the burst release section of the substance-release profile ends briefly and then gradually changes to a plateau, or a sustained release phase in the release profile.

The phrase “sustained release”, as used herein, refers to the section of the substance-release profile which comes after the burst release part, and is typically characterized by constant (substantially linear) rate and relative long duration over an extended periods of time until the substance's reservoir is exhausted.

The main differences between the burst and the sustained phases of a substance-release profile are therefore the rate (slope characteristics) and duration, being exponential and short for the burst release, and linear and long for the sustained release; and both play a significant role in designing systems for substance release, as presented herein. In most cases, the presence of both a burst release phase and a sustained release phase is unavoidable and stems from chemical and thermodynamic properties of the substance-releasing system.

In the context of embodiments of the present invention, the phrase “high burst release” is an attribute of a substance-releasing system, as described herein, which refers to the amount of the substance that is being released from the system during the initial stage of exposure of the system to the environment of its action (e.g., aqueous medium, irrigated soil etc.), wherein the amount is in excess of 20% of the total amount of the substance contained (encapsulated) in the system and the initial phase is within the first 10 days from commencement of exposure. Alternatively, a high burst release is defined as the release of 20% of the contained substance within the first 5 days of exposure, or release of 20% of the contained substance within the first 15 days of exposure, or release of 20% of the contained substance within the first 20 days of exposure, or release of 20% of the contained substance within the first 25 days of exposure. In some embodiments of the present invention, “high burst release” describes an attribute of a substance-releasing system, as described herein, in which 30%, 40%, 50%, 60% and even higher percentages of the substance are released during the first 10 days of exposing the system to an environmental medium. Any value between 20% and 100% of the substance are contemplated.

Accordingly, the phrase “low burst release” refers to substance-releasing systems wherein less than 20% of the contained substance is released within the first 10 days of exposure. Alternatively, a low burst release is defined as the release of 20% or less of the contained substance within the first 25 days of exposure, or release of 20% or less of the contained substance within the first 20 days of exposure, or release of 20% or less of the contained substance within the first 15 days of exposure, or release of 20% or less of the contained substance within the first 5 days of exposure. In some embodiments of the present invention, “low burst release” describes an attribute of a substance-releasing system, as described herein, in which 15%, 10%, 5% and even lower percentages of the substance are released during the first 10 days of exposing the system to an environmental medium. Any value between 20% and 1% of the substance are contemplated.

According to some embodiments of the present invention, the truly-closed-cell microstructure of the composition-of-matter presented herein, is identified and characterized by a low burst release such that less than 20% of the entrapped substance is released from the composition-of-matter over a period of at least 10 days when the composition-of-matter is exposed to the aqueous environment. In some embodiments, the substance-release profile exhibited from the presently disclosed composition-of matter is essentially devoid of an exponential phase.

Alternatively, or at least 95% of the time during which the substance is released from the composition-of-matter is not exponential (substantially linear) as can be assessed qualitatively by inspecting the substance-release profile. In some embodiments the substance-release profile is substantially linear for at least 90% of the time during which the substance is released from the composition-of-matter, or at least 85%, 80% 75%, or at least 70%.

According to some embodiments of the present invention, the time period over which the composition-of-matter presented herein is capable of exhibiting a sustained (substantially linear or constant over time) release profile when in contact with an aqueous environment, such as wet soil, ranges from 1 month to one year. In some embodiments, the time period is more than 1 month, or more than 2, 3, 4, 5, 6, 7, 8, 9, 10, 11, 12, 13, 14, 15, 16, 17, 18, 19, 20, 21, 22, 23, 24 months or more. In some embodiments, the time period ranges from 1 to 2 months, 2-3 months, 3-4 month, 4-5 months, 5-6 months, 6-7 months, 7-8 months, 8-9 months, 9-10 months, 10-11 months, or 11-12 months.

The composition-of-matter presented herein is highly effective serving as a substance-releasing system in moist and wet environments, wherein such an environment is defined as a medium that can contain water to some extent and that can come in direct physical contact with the composition-of-matter. According to some embodiments, an environment into which the composition-of-matter presented herein can release its encapsulated substance, at least to some extent, includes water, aqueous solutions, soil, synthetic plant bed material, wood and wood particles, humus, sand, silt, gravel, loam, clay, any material that can become wet, soaked or moist with water, and any combination thereof.

In some embodiments, the environment into which the substance is released is a solid, liquid or gaseous environment. In some embodiments the environment is an aqueous environment.

In some embodiments, the aqueous environment into which the composition-of-matter presented herein can release its encapsulated substance, at least to some extent, is characterized by having a water content that ranges from 0.01 to 1 volume per volume (vol/vol), wherein water is considered as having a water content of 1; or from 0.01 to 0.25 vol/vol, which is considered the minimum soil moisture at which a plant wilts; or from 0.1 to 0.35 vol/vol, which is considered to be the moisture in soil about 2-3 days after rain or irrigation; or from 0.2 to 0.5 vol/vol, which is considered as the moisture of fully saturated soil (equivalent to effective porosity of the soil); or from 0.4 to 0.75 vol/vol, or from 0.5 to 1 vol/vol. In some embodiments, the water content of the aqueous environment to which the composition-of-matter presented herein can release its encapsulated substance upon contact is at least 0.01 vol/vol, 0.02 vol/vol, 0.04 vol/vol, 0.06 vol/vol, 0.08 vol/vol, 0.1 vol/vol, 0.12 vol/vol, 0.14 vol/vol, 0.16 vol/vol, 0.18 vol/vol, 0.2 vol/vol, 0.22 vol/vol, 0.24 vol/vol, 0.26 vol/vol, 0.28 vol/vol, 0.3 vol/vol, 0.32 vol/vol, 0.34 vol/vol, 0.36 vol/vol, 0.38 vol/vol, 0.4 vol/vol, 0.42 vol/vol, 0.44 vol/vol, 0.46 vol/vol, 0.48 vol/vol, 0.5 vol/vol, 0.52 vol/vol, 0.54 vol/vol, 0.56 vol/vol, 0.58 vol/vol, 0.6 vol/vol, 0.62 vol/vol, 0.64 vol/vol, 0.66 vol/vol, 0.68 vol/vol, 0.7 vol/vol, 0.72 vol/vol, 0.74 vol/vol, 0.76 vol/vol, 0.78 vol/vol, 0.8 vol/vol, 0.82 vol/vol, 0.84 vol/vol, 0.86 vol/vol, 0.88 vol/vol, 0.9 vol/vol, 0.92 vol/vol, 0.94 vol/vol, 0.96 vol/vol, 0.98 vol/vol or at least 0.99 vol/vol.

### Encapsulated Substance:

As discussed hereinabove, the composition-of-matter presented herein exhibits a capacity to releasably encapsulate substances that are entrapped in the polyHIPE at considerably highly concentrations/contents, which renders the formation of a HIPE and the polymerization of its external phase a challenging feat. Considering that the substance essentially constitutes the internal phase of the precursor HIPE, any reference herein to the encapsulated substance of the composition-of-matter presented herein is equivalent to a reference to the internal phase of the precursor HIPE, unless stated otherwise. According to some embodiments of the present invention, the encapsulated substance is characterized by having no more than 80% of water therein, or less than 75%, less than 70%, less than 65%, less than 60%, less than 55%, less than 50%, less than 45%, less than 40%, less than 35%, less than 30%, less than 25%, less than 20%, less than 15%, less than 10%, or less than 5 percent by weight water of the total weight of the internal phase of the precursor HIPE.

While the internal phase of the HIPE can be chemically inert as far as the polymerization process of the external phase is concerned, the contents of the internal phase may have a beneficial or a deleterious effect on the stability of the HIPE. Thus, one of criteria for defining the encapsulated substance in the context of embodiments of the present invention, includes inter alia, the ability of the substance to partake as the internal phase of the precursor HIPE in the generation of the precursor HIPE en route to a polyHIPE. In addition, the substance is required to be conducive to, or at least passively allow the polymerization process to occur in the external phase of the HIPE.

Another criterion for defining the encapsulated substance in the context of embodiments of the present invention, is that at least a part and/or a component thereof, which is not a solvent thereof (e.g., water), is released from the polyHIPE when the composition-of-matter is exposed to an environment, as discussed herein.

In some embodiments, the internal phase includes optional ingredients that form a part of the entrapped substance. In some embodiments, the optional ingredients in the internal phase are meant to be released with the releasably entrapped substance such as fertilizers, insecticides and herbicides, or confer some properties to the composition-of-matter, such as polymer-degradation inducing agents, corrosion inhibitor, colorants, odoriferous and scented materials, pH-setting agents, and the likes. Thus, in some embodiments, the releasable substance is selected from the group consisting of a fertilizer, an insecticide, an herbicide, a phase-change material, a bioactive agent, a drug, an antibiotic agent, a polypeptide, an antibody, a catalyst, an anticorrosion agent, a fire retardant, a sealing agent, an adhesive agent, a colorant, an odoriferous agent, a lubricant and any combination thereof.

In some embodiments, the internal phase is a concentrated aqueous solution having at least 1%, 5%, 10%, 20%, 30%, 40%, 50%, 60%, 70%, 80% or at least 90% of dissolved and/or suspended solids therein. In some embodiments, the internal phase is a saturated aqueous solution exhibiting an equilibrium of solid and dissolved species of the substance. Alternatively, internal phase is a liquefied (molten) room temperature solid. In some embodiments, the internal phase is an ionic liquid, or a room temperature ionic liquid. Alternatively, internal phase of the HIPE is an emulsion by itself, and the HIPE can be an oil-in-water-in-oil emulsion prior to polymerization of the external phase of the HIPE. Alternatively, the internal phase is a suspension or a slurry of solid particles in a liquid medium. In some embodiments, the internal phase is a colloid of solid particles in a liquid medium. In any of the aforementioned forms of the encapsulated substance, it is regarded as at least a part of a liquid internal phase of the precursor HIPE, and since it is immiscible with the external organic phase, it may be referred to as the dispersed internal phase albeit the content of water therein may be null or minimal, as in the case of some hydrate melts.

Unlike water or low concertation aqueous solutions, highly concentrated solutions, suspensions, colloids, emulsions and/or molten materials that are room temperature solids, present a challenge in stabilizing the precursor HIPE en route to polymerization to the corresponding polyHIPE. These internal phase forms comprising highly concentrated substances differ from water or their corresponding low concentration solutions by their chemical, physical and mechanical properties, such as ionic strength, specific gravity, rheology (viscosity), flow behavior, temperature and the like, all of which play a role in the ability of a HIPE to form and be sufficiently stable. Molten room temperature solids add, on top of the aforementioned challenges, the heat required to maintain the room temperature solids in a liquid form until the HIPE has been formed and stabilized.

In some embodiments, the solute or solid, forming a part of the internal phase, is a substance that is a salt or a highly soluble, moderately soluble or poorly soluble inorganic or organic material. It is noted that the solute or solid discussed herein, which is present in the internal phase at relatively high concentrations, may be seen as a thickening agent, as this term is discussed hereinabove, which improves the formability and stability of a HIPE en route to polymerization thereof.

In some embodiments of the present invention, the encapsulated substance is a liquid having at least 20% by weight solids dissolved and/or suspended in the liquid media. In some embodiments, the total dissolved and/or suspended solids in the encapsulated substance (the internal phase of the precursor HIPE) is at least 20% by weight of the total weight of the internal phase, or at least 25%, 30%, 35%, 40%, 45%, 50%, 55%, 60%, 65%, 70%, 75%, 80%, 85%, 90%, or at least 95%. In some embodiments where the internal phase is a molten room temperature solid, the total dissolved and/or suspended solids in the encapsulated substance is essentially about 100%.

In some embodiments, the solute, suspension or solid matter in the internal phase is a fertilizer or a precursor of a fertilizer, or a substance that is known to be beneficial for plant growth, such as, but not limited to ammonium nitrate, ammonium polyphosphate, ammonium sulfate, anhydrous ammonia, ammonia derivatives, calcium nitrate, diammonium phosphate, gypsum (calcium sulfate dihydrate), urea and urea derivatives, urea nitrate, urea phosphate, urea sulfate, ureaform, isobutylidene diurea, methylene urea, potassium magnesium chloride, monoammonium phosphate, monocalcium phosphate, monopotassium phosphate, magnesium oxide or hydroxide, calcium oxide or hydroxide, potassium chloride, potassium sulphate, potassium magnesium sulfate, potassium nitrate, magnesium sulphate, magnesium nitrate, zinc sulphate, zinc nitrate, boric acid, borate salts, tetraborates, phosphoric acid, sulfuric acid, nitric acid, iron sulfate, manganese sulfate, and any combination thereof.

In some embodiments, the entrapped substance is a room temperature solid, which is seen as equivalent in the context of embodiments of the present invention, to a TDS (total dissolved solids) content of 100%. In the context of embodiments of the present invention, the term “room temperature solid” refers to a substance that can be rendered liquid (molten) under conditions in which a HIPE can be formed, stabilized and polymerized. In some embodiments, the room temperature solid is a substance with a melting point lower than 90° C., lower than 80° C., or lower than 70° C. In some embodiments, the room temperature solid is a substance that can be liquefied into a liquid which is immiscible in an organic solvent, and more specifically, immiscible in the external phase of the HIPE. This term excludes room temperature solids that cannot be encapsulated in the voids of a polyHIPE by adding them as suspended particles in the droplets of the dispersed internal phase of the precursor HIPE. In the context of some embodiments of the present invention, the room temperature solid can be a eutectic, a phase-change material (PCM) and the likes. In some embodiments, the room temperature solid is a fertilizer or a substance that is known to be beneficial for plant growth, such as, but not limited to hydrates of calcium nitrate, such as the tetrahydrate. Other room temperature solid fertilizers, that can be encapsulated in a polyHIPE, according to some embodiments of the present invention, include hydrates of calcium chloride such as calcium chloride hexahydrate and calcium chloride tetrahydrate, hydrates of magnesium nitrate such as magnesium nitrate heptahydrate and magnesium nitrate undecahydrate, hydrates of magnesium sulfate, ammonium sulfate, various eutectics of urea ammonium nitrate (UAN) or as obtained from mixtures of urea with salts such as potassium or ammonium or calcium or magnesium nitrate, sulfate, bisulfate, phosphate, dihydrogenphosphate, monohydrogen phosphate, polysulfide or thiocyanate, sodium sulfate decahydrate, sodium carbonate decahydrate, sodium phosphate dibasic dodecahydrate, iron(III) nitrate nonahydrate, aluminum nitrate nonahydrate, sodium phosphate tribasic dodecahydrate, sodium aluminium sulfate dodecahydrate, zinc nitrate terahydrate, sodium thiosulfate pentahydrate, sodium metasilicate penta- or nonahydrate, magnesium nitrate hexahydrate, and any combinations thereof. In some embodiments, the room temperature solid is a deep eutectic solvent of different types that from a eutectic mixture of Lewis or Brøonsted acids and bases which can contain a variety of anionic and/or cationic species, such as choline chloride and urea in a 1:2 mole ratio, and deep eutectic mixtures of urea with benzoquinones that polycondense to form water soluble oligomer chains.

In some embodiments, the aqueous phase, or the encapsulated substance, includes hydrophilic monomers or polymerizable oligomers, which can be polymerize and/or crosslinked to produce an entrapped polymer solution or an entrapped hydrogel that can be swollen with water. In some embodiments, the thickening agent can also be polymerized and/or crosslinked within the droplets prior to, during, or post polymerization of the external phase. For example, the alginate can be crosslinked before, during or after the external phase polymerization. Exemplary hydrogels that can be formed within the voids on the polyHIPE include, without limitation hydroxyethyl methacrylate (HEMA) and N,N′-methylenebis(acrylamide) (MBAM), whereas these hydrophilic polymers tend to be aqueous solution-swollen hydrogels, thereby forming a composition-of-matter, which according to some embodiments of the present invention, comprises an elastomeric matrix entrapping a swollen hydrogel or a polymer having the capacity of swelling in water. It is noted that an entrapped hydrophilic polymer having the capacity of swelling or dissolving in water can contribute to the polyHIPE-degradation mechanism; when a composition-of-matter entrapping such polymer is exposed to an aqueous environment, the hydrogel can swell sufficiently to rupture the walls of the elastomer, thereby degrading its microstructure and exposing the contents of the closed-cells.

Process of Preparation:

According to an aspect of some embodiments of the present invention, there is provided a process of preparing the composition-of-matter presented herein, the process includes preparing and subjecting a high internal phase emulsion (HIPE) having an internal phase and a polymerizable external phase to polymerization of the polymerizable external phase, the polymerization is initiated substantially at an interface between the polymerizable external phase and the internal phase, wherein the HIPE is prepared and stabilized without the use of HIPE-stabilizing particles/nanoparticles.

In some embodiments, the internal phase is an aqueous phase and the polymerizable phase in an organic polymerizable phase. The phases are mixed thoroughly so as to achieve a water-in-oil HIPE using a thickening agent in the internal phase at a concentration that brings its viscosity closer to the viscosity of the external phase that includes at least one oligomer.

The HIPE is prepared at a temperature at which the phases are both in a liquid state. In some embodiments, the temperature at which the HIPE is prepared ranges from 0° C. to 100° C., or 25-80° C., or 35-80° C., depending on the contents of the phases, and particularly the internal phase. For instance, if the internal phase includes a room-temperature solid, the HIPE is prepared at the temperature at which the solid melts to a mixable liquid or higher, but lower than its boiling point. In some embodiments, the HIPE is prepared at a temperature lower than the activation temperature of the polymerization initiator, and once afforded, the temperature is raised to the activation temperature so as to effect polymerization of the external phase of the HIPE.

Article-Of-Manufacturing:

According to yet another aspect of the present invention, there is provided an article-of-manufacturing which includes, or is based on the LDE compositions-of-matter presented herein.

By virtue of being elastomeric and containing a considerable amount of entrapped liquid or releasable substance, the article-of-manufacturing can benefit from both these characteristics, and combine these in one article-of-manufacturing, typically attainable with two or more products.

For example, LDEs can be used to form stretchable isolating films, sheets, blocks or otherwise any object, that when punctured or penetrated, ooze a solution containing a substance such as, without limitation, a fertilizer, a pesticide, an herbicide, a bioactive agent, a drug, an antibiotic agent, a polypeptide, an antibody, a catalyst, an anticorrosion agent, a fire retardant, a sealing agent, an adhesive agent, a colorant, an odoriferous agent, a lubricant, and any combinations thereof.

The nature and optimal use of the article-of-manufacturing made from the LDEs presented herein depends on the nature of the matrix and the liquid entrapped therein. Due to the ratio of liquid to matrix, the liquid being the major component of the composition-of-matter, would have a more profound influence on the practical uses thereof. For example, a liquid with high energy absorption properties, such as, for example aqueous solutions of hydroxypropyl methylcellulose and other viscoelastic liquids, will render the composition-of-matter more suitable for use in the manufacturing of an article for impact absorption. In another general example, a composition-of-matter exhibiting an entrapped solution of an active agent will be suitable for use in the manufacturing of an article wherein leakage of the solution concurrent to impact effects delivery of the solution at the location of the puncture caused by the impact.

The article-of-manufacturing can benefit from the flexibility of the elastomeric matrix and energy-absorbing and dissipating capacity of the entrapped liquid, and be used as, for non-limiting example, an energy absorption and dissipation article (insoles, bike seats cushions, carpet underlay, etc.), a vibration absorption article (motor mounts, loudspeaker mounts, etc.), a noise absorption article (quiet-room insulation, earplugs, etc.), a cushioning article, a thermal insulating article (cold/hot packs, refrigerator and air-conditioning insulation, etc.), and an impact protection article (protective sportswear, battle gear, etc.).

In cases where the liquid is an aqueous solution, LDEs can be used as dampening material, moisture and humidity control material, fire resistant material, etc.

When having a biologically active agent as a solute in the entrapped liquid, the LDEs can be used to form surgical gloves, septum seals, and other medical devices wherein a drug or a disinfectant is required upon penetration of a barrier. An exemplary use of an LDE is the manufacturing of an elastomeric glove with a sealant and colored liquid entrapped in the elastomeric matrix. Such a glove, when accidentally punctured, will provide self-sealing and breach warning functionality to the user.

When using a labile elastomer, the article-of-manufacturing can be used for deploying a releasable substance while being environmentally friendly. As such, the composition-of-matter presented herein can be designed as a substance-releasing system that is custom-made for a specific utility, such as needed in agriculture and plant management. In some embodiments, the composition-of-matter releasably encapsulates a fertilizer composition, while being designed to release the fertilizer in a substantially linear profile over a time-period when the plant requires more nutrition.

In some embodiments, the composition-of-matter can be incorporated into an agricultural article-of-manufacturing, or device, for delivering water in a controllable release profile to irrigate or moisten an environment it is deployed in.

In some embodiments, an insecticide or an herbicide is present in the releasably encapsulated substance to afford a composition-of-matter that can be incorporated into an agricultural article-of-manufacturing, or device, for delivering insecticides or herbicides.

In some embodiments, the composition-of-matter releasably encapsulates a disinfecting composition for potable, irrigation or recreational water reservoirs (swimming pools), while being designed to release the disinfectant(s) in a substantially linear profile over an extended time-period such that the rate of release commensurate the rate of decomposition and degradation of the disinfectant(s) in the water due to ambient conditions (light, heat, reactivity etc.).

Hence, according to an aspect of some embodiments of the present invention, the composition-of-matter forms a part, or is a substance-releasing system, having a releasably encapsulated substance therein. In some embodiments, the substance induces, without limitation, water and any mineral or organic fertilizer, an herbicide, a pesticide, a plant growth stimulator and any other biostimulant, a plant protector and any other biocontrol agent, a plant disease control agent, an agent that enhance ectomycorrhiza in the rhizosphere, plant growth-promoting rhizobacteria and rhizofungi, a growth regulator, a hormone, plant extract, an amino acid, a peptide, an odoriferous material, a fragrance, a pH-adjusting agent, a colorant, a disinfectant, and any combination thereof.

Due to their unique mechanical properties, the composition-of-matter can be cast in the liquid HIPE form into any shape and size mold before polymerization, or they can be reshaped and further processed post casting and polymerization. The composition-of-matter can therefore take any size of a block, a sphere, a bead, a rod, a particle (powder), a flat or shaped sheet, a tube or a fiber.

A non-limiting example of a product based on the substance-releasing system presented herein is a degradable polyHIPE that in the form of pellets that can be spread over agricultural land, which releases an encapsulated fertilizer into the soil when the soil is wet, whereas the fertilizer is released substantially linearly over a period of time that overlaps with the crop's growth period, and decomposes at the end of the fertilizer releasing period into benign and environmentally friendly degradation products.

It is expected that during the life of a patent maturing from this application many relevant truly-closed-cell polyHIPEs (LDEs) devoid of HIPE-stabilizing particles will be developed and the scope of the term LDE devoid of HIPE-stabilizing particles is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions; illustrate the invention in a non-limiting fashion.

### Example 1

### Materials and Methods

Highly Viscous HIPEs—Materials:

Some of the polyHIPEs presented herein were based on 2-ethylhexyl acrylate (EHA, Aldrich) and an oligomeric polybutadiene (PB, 1800-2200 g/mol, Aldrich). The EHA monomer was purified to remove the inhibitor by passing it through a column of basic alumina (activated, basic, Brockmann I aluminum oxide, Aldrich). The molecular structure of PB is predominantly from a 1,2-addition reaction (about 90% reactive pendent vinyl groups) and it was used as received.

The HIPE stabilizer was the surfactant (emulsifier) sorbitan monooleate (SMO, Fluka Chemie).

Potassium persulfate (KPS, K₂S₂O₈, Riedel-de-Haen) was used for a water-soluble initiator, and benzoyl peroxide (BPO, Aldrich) was used as an organic-soluble initiator.

Potassium sulfate (K₂SO₄, Frutarom) was added to the aqueous phase as a HIPE stabilization enhancer.

Alginate (also called alginic acid) was used as a thickening agent. Alginate is an anionic polysaccharide synthesized from sodium alginate, a natural polymer extracted from brown seaweed.

Highly Viscous HIPEs—Synthesis:

PolyHIPEs were synthesized within highly viscous w/o HIPEs. The HIPE was formed by adding the aqueous phase dropwise to the organic phase. The organic external phases of some of the HIPEs herein contain oligomeric species, which significantly increase the viscosity of the HIPE. As was found, the HIPEs were severely destabilized by the high viscosity of the external phase and it was practically impossible to incorporate the high internal phase contents needed for HIPE formation.

In order to overcome the HIPE's destabilization caused by the high viscosity of the external phase, the viscosity of the internal phase was brought closer to that of the external phase, by adding about 2 wt % of alginate to the internal phase. Therefore, for some of these HIPEs, the stirring rate was intermittently increased to about 550 rpm (depending on the oligomer content and viscosity). In some cases manual mixing by spatula was also needed to ensure dispersion of the internal phase within the external phase.

Specifically, in some examples, KPS, the stabilizing salt (i.e., K₂SO₄ or NaCl) and alginate were dissolved in deionized water under vigorous stirring (using a magnetic stirrer) in a 100 ml glass beaker. In parallel, the organic phase components, namely the monomer EHA, oligomer PB and emulsifier SMO, were added to a 100 ml polypropylene beaker and stirred (200 rpm) for about 2 minutes. The stirring rate was then raised to 400 rpm and the aqueous phase was added dropwise to the organic phase, using a dripping funnel, with dripping rate of approximately 1 droplet per 4 seconds. The mass fraction (Pᵢₙ, wt %) of the internal phase incorporated in the HIPEs ranged from 77 to 85 wt % and is reported for each polyHIPE system (Pₑₓ in wt % is the corresponding fraction of the external phase). The resulting HIPE was covered with parafilm and aluminum foil and placed in a convection oven at 65° C. (unless otherwise stated) for 24 hours. The resulting polyHIPE underwent drying in a freeze-drier for about 3 days to try and remove the water (unless otherwise stated).

The resulting polyHIPEs were labeled ‘PB-x/i/s’, where ‘PB’ denotes the oligomeric comonomer 1,2-polybutadiene (PB), ‘x’ denotes the relative amount (wt %) of PB in the monomers (i.e. 100-'x′ is the relative amount of EHA), ‘i’ denotes the type of initiator (K for KPS, B for BPO), and ‘s’ denotes the stabilization strategy (SF for surfactant-stabilized HIPEs). The organic phase consisted of monomers/oligomers and emulsifier. The aqueous phase consisted of deionized water with alginate and stabilizing salt. In the polyHIPEs from interfacial initiation, the water-soluble initiator (KPS) was also dissolved in the aqueous phase before the addition of the phase dropwise into the organic phase. In the polyHIPEs from organic-phase initiation, the organic-soluble initiator (BPO) was first dispersed in the EHA, and then the rest of the organic components were added to the external phase.

Initially, a few experiments were done to achieve bulk copolymerization of PB/EHA (50/50 mass ratio) using different amounts of BPO or KPS. The minimum initiator to monomer ratio that initiated polymerization for BPO was 0.062 g/g, while for KPS the ratio was 0.023 g/g. In practice, the mass of BPO was 2.5 times higher (the number of moles was 2.8 times higher) than that of KPS, for a given monomer mass. Moreover, in accordance with common practice, the polymerization temperature for the organic-phase initiation with BPO was 85° C., instead of the 65° C. used for interfacial initiation with KPS.

The HIPE recipes for the EHA-PB copolymer polyHIPEs are listed in Table 1.

TABLE 1

| | HIPE Composition, wt % | | | |
|---|---|---|---|---|
| PolyHIPE | PB-50/B/SF | PB-70/B/SF | PB-50/K/SF | PB-70/K/SF |

External organic phase

| | | | | |
|---|---|---|---|---|
| PB | 6.80 | 9.52 | 7.20 | 10.08 |
| EHA | 6.80 | 4.08 | 7.20 | 4.32 |

| | | |
|---|---|---|
| BPO | 0.84 | — |
| SMO | 3.48 | 3.47 |
| Total | 17.92 | 17.87 |

Internal aqueous phase

| | | |
|---|---|---|
| water | 80.04 | 79.75 |
| KPS | — | 0.34 |
| K2SO4 | 0.41 | 0.41 |
| Alginate | 1.63 | 1.63 |
| Total | 82.08 | 82.13 |

Synthesis Parameters Summary:

The HIPE synthesis parameters are summarized in Table 2. All polyHIPEs resulted from HIPEs stabilized by adding a thickening agent (alginate) to the aqueous phase, and by using a surfactant emulsifier HIPE stabilizer (SMO), and were split in the locus of initiation through the use of different initiators.

TABLE 2

Locus of Initiation

| | Interface | Organic-phase |
|---|---|---|
| PB-50/B/SF | | + |
| PB-50/K/SF | + | |
| PB-70/B/SF | | + |
| PB-70/K/SF | + | |

PolyHIPE Porous Structure Characterization:

The porous structure was investigated using secondary electron (SE) imaging in a scanning electron microscope (SEM, FEI Quanta 200) of gold-palladium coated cryogenic fracture surfaces (unless otherwise stated). The range of void diameters was estimated by analyzing the low magnification SEM images. The fracture surfaces were generated by immersing the samples in liquid nitrogen, waiting about 1 to 3 minutes, removing the samples, and pulling on both ends with tweezers to fracture the sample.

Thermal Properties Characterization:

The thermal properties of the polyHIPEs were characterized using differential scanning calorimetry (DSC, Mettler DSC -821e calorimeter) in nitrogen. The samples underwent three thermal runs. The first run was heating from −85° C. to a temperature between 170° C. and 240° C. (t_{f}), the second run was cooling from t_{f} to −85° C., and the third run was heating again from −85° C. to t_{f}. The rates of heating/cooling were 10° C./min. The parameters derived from the DSC analysis were the glass transition temperature (T_{g}), the heat of the water melting endotherm (ΔH_{wm}), and the dehydration temperature for the water associated with the alginate.

Water Content Determination:

The mass fraction of water in the polyHIPE after drying, w, was calculated using Equation 1:

$$w = \frac{Δ {H}_{wm}}{Δ {H}_{wm ( theo )}} ; \qquad Equation 1$$

wherein ΔH_{wm} is the heat of the water melting endotherm per gram polyHIPE, measured from the DSC thermogram, and ΔH_{wm(theo)} is the theoretical value of the heat of melting per gram for water, which is approximately 334.8 J/g.

The polyHIPE's water retention, W_{R}, was calculated using Equation 2:

$${w}_{R} = \frac{w}{100 - {P}_{ex}} ; \qquad Equation 2$$

wherein Pₑₓ is the weight percentage (wt %) of the HIPE's external phase.

Density and Porosity Characterization:

The polyHIPE density, d, was determined by measuring the mass and the volume of several specimens. The specimens were cubes of approximately 1 cm³, cut with a scalpel. The theoretical polyHIPE density is calculated from the HIPE recipe assuming that the polymer and the water densities, ρₚ and ρ_{w}, respectively, are 1 g/cm³. The polyHIPE porosity (P), which is the relative volume occupied by “air” (empty voids) and by residual water (filled voids), was calculated from the volume of water per gram polyHIPE (V_{w}) and the volume of “air” per gram polyHIPE (Vₐ), using Equation 3. Given w (the mass fraction of water in the polyHIPE after drying, Equation 1) the polymer mass fraction in the polyHIPE is (1-w). V_{w} and the volume of polymer per gram polyHIPE, V_{P}, can be calculated by Equation 4 and Equation 5, respectively, assuming that the polymer and the water densities, ρₚ and ρ_{w}, respectively, are both 1 g/cm³. The polyHIPE volume per gram, V_{T}, can be calculated from the polyHIPE density (Equation 6). Vₐ, the volume of “air” in the polyHIPE, can be calculated by subtracting the volumes of the polymer and the water (Vₚ and V_{w}, respectively) from the total volume (V_{T}), as seen in Equation 7. Finally, substituting V_{w}, Vₐ and V_{T} into Equation 3 gives the polyHIPE porosity.

$$\begin{matrix}P = \frac{{V}_{w} + {V}_{a}}{{V}_{T}} ; & Equation 3 \\ {V}_{w} = \frac{w}{{ρ}_{w}} ; & Equation 4 \\ {V}_{p} = \frac{1 - w}{{ρ}_{p}} ; & Equation 5 \\ {V}_{T} = \frac{1}{d} ; & Equation 6 \\ {V}_{a} = {V}_{total} - {V}_{w} - {V}_{p} ; & Equation 7\end{matrix}$$

Mechanical Properties:

The mechanical properties were characterized using compressive stress-strain tests that were conducted (Instron 3345) at room temperature. The measurements were carried out on the freeze-dried samples (unless otherwise stated), until a deformation of 70% was reached, whereas the limit of 70% was chosen due to machine limitations. The fits to a modulus model (either a Young's modulus model or a rubber elasticity (RE) modulus model) were carried out according to the shape of the curve and an evaluation of the linearity of the fit. The Young's compression modulus (elasticity modulus), E, was determined from a linear fit to the stress versus strain curves at low strains (σ=Eε). The RE modulus, E_{RE}, was determined from a linear fit to the stress versus (λ−(1/λ²)) curves at low strains.

The polyHIPEs were weighed before the compression tests and the polyHIPEs that did not completely collapse during the test were weighed after as well.

Molecular structure:

The molecular structures were characterized using Fourier transform infrared (FTIR) spectroscopy. The FTIR spectra were collected from ground polyHIPEs which were mixed with KBr to form pellets (Bruker Equinox 55 FTIR). The dry polyHIPEs were ground with KBr powder, using a mortar and pestle.

### Example 2

### Results and Discussion

Highly Viscous PolyHIPEs—General Approach:

The approach taken for the exemplary polyHIPEs presented herein was to introduce oligomers based upon polybutadiene (PB) into the macromolecular structure. The introduction of such elastomeric oligomers into the continuous external phase, however, produced a significant increase in its viscosity and disrupted HIPE stability. In general, increasing the viscosity of the continuous organic phase reduces the volume of the dispersed phase that can be added without destabilizing the HIPE. The high viscosity of the external phase prevents efficient mixing of the system, producing larger internal phase droplets. Hence, higher stirring rates were needed in some cases and, in addition, combining the mechanical stirring with manual mixing using spatula. The solution to this problem, namely enhancing HIPE stability, albeit somewhat counter-intuitive, involved increasing the viscosity of the dispersed internal phase so as to bring its viscosity closer to that of the continuous phase. Based on the same concept of increasing the phase viscosity by adding an oligomer, the internal phase viscosity was increased by adding a thickening agent, e.g., in the form of a hydrophilic polymer/oligomer. The hydrophilic polymer used in this embodiments was alginate.

Three innovative families of polyHIPEs containing elastomeric oligomers were successfully synthesized, owing to the introduction of alginate into the internal, aqueous phase. Determining the optimal amount of alginate can be found experimentally, as too much alginate produced viscosities that disrupted controlled dripping, and reduced the effectiveness of mixing. In some embodiments of the present invention the optimal alginate concentration was about 2 wt % of the dispersed aqueous phase. Hence, the exemplary polyHIPEs demonstrated herein contained about 2 wt % alginate in the dispersed aqueous phase, unless otherwise stated.

The presence of the alginate is detected in the SEM images of the polyHIPEs and is also reflected in the DSC thermograms. Alginate, with a relatively high amount of hydrophilic groups along the backbone, adsorbs water. The DSC thermograms of thoroughly dried polyHIPEs containing alginate, exhibit a broad endotherm reflecting a certain amount of water associated with alginate dehydration. Alginate dehydration usually occurs at about 80° C. and is shown as a broad endotherm in the DSC thermograms.

EHA-PB Copolymer PolyHIPEs—Properties:

The exemplary polyHIPEs demonstrated herein consist of copolymers of EHA and a PB oligomer, wherein PB fills the role of a crosslinking comonomer. The PB/EHA copolymer polyHIPEs differ by the PB/EHA weight ratio (50/50 and 70/30) and the locus of initiation, and some of their properties are listed in Table 3.

TABLE 3

| | Pₑₓ, | T_{g}, | d, | w, | w_{R}, | | E, |
|---|---|---|---|---|---|---|---|
| Sample | wt % | ° C. | g/cc | wt % | % | P | kPa |
| PB-50/B/SF | 18 | −29 | 0.32 | 0 | 0 | 0.68 | 76.5 |
| PB-50/K/SF | 18 | −37 | 0.63 | 37 | 45 | 0.59 | 34.4 |
| PB-70/B/SF | 18 | −25 | 0.35 | 0 | 0 | 0.65 | 41.3 |
| PB-70/K/SF | 18 | −35 | 0.82 | 63 | 77 | 0.70 | 30.3 |

Locus of Initiation:

Previous work has demonstrated that changes in the locus of initiation can produce dramatic changes in the porous structure and properties of both surfactant-stabilized and NP-stabilized polyHIPEs, as will be described below for the surfactant-stabilized polyHIPEs.

Surfactant-Stabilized HIPEs:

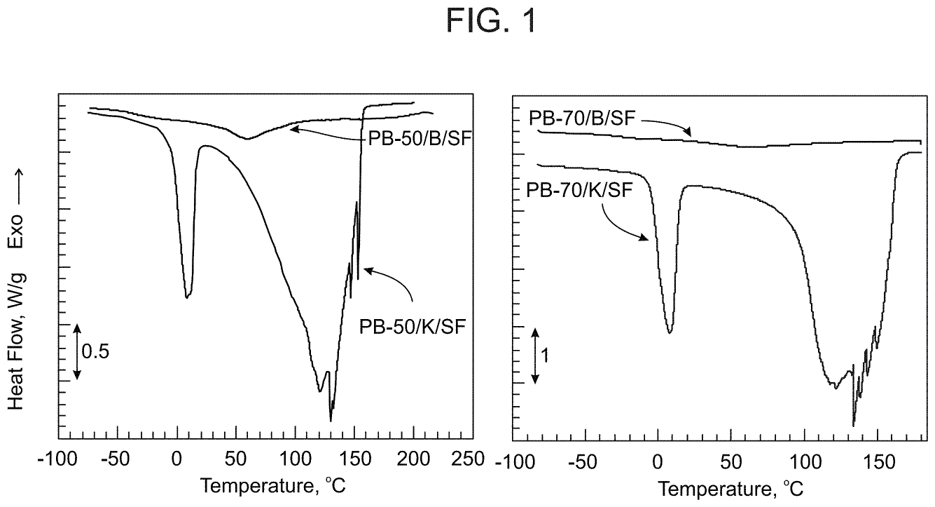

Interfacial initiation yields more closed-cell-like polyHIPEs, compared to the more open-cell structure of organic-phase initiated polyHIPEs. Closed-cell structures encourage water retention. Moreover, since the initiator (KPS) is in the aqueous phase and the crosslinking agent (PB) is more hydrophobic than the monomer, interfacial initiation may promote less reaction with the PB, resulting in a lower crosslinking density, and therefore, in a more elastomeric polymer. Elastomeric polymer walls also impede water transport. Hence, the elastomeric behavior of the closed-cell-like interfacially initiated polyHIPEs prevented water removal, leading to a higher water retention (W_{R}) capability, as seen in Table 3. These values are derived from the DSC thermograms in FIG. 1, which clearly show the differences in the water storage behaviors between the organic-phase initiated polyHIPEs (PB-50/B/SF and PB-70/B/SF) and the interfacially initiated polyHIPEs (PB-50/K/SF and PB-50/K/SF). There are water melting and boiling peaks at around 0 and 100° C., respectively, in the PB-50/K/SF and PB-70/K/SF thermograms, but not in the PB-50/B/SF and PB-70/B/SF thermograms.

FIG. 1 presents DSC thermograms (first heat) of exemplary surfactant-stabilized polyHIPEs, according to some embodiments of the present invention, comparing the effect of the locus polymerization initiation on water retention.

Hence, the interfacially initiated polyHIPEs from surfactant-stabilized HIPEs exhibited water retention, while polyHIPEs from an almost identical recipe, but via organic-phase initiation, did not. The water boiling peaks for PB-50/K/SF and PB-50/K/SF are not as sharp and narrow as the melting peaks, since the vaporization is impeded by the highly elastomeric polymer walls. Therefore, the water retention capability (W_{R}, Table 3) in these sample is relatively high from the outset, even though the polyHIPEs were dried under the same stringent conditions (as described hereinabove). For the interfacially initiated polyHIPEs, increasing the amount of PB from 50 to 70% produced an increase in the water retention, W_{R}, from 45 to 77, reflecting the more hydrophobic nature of the PB which reduces the diffusion rate of water through the walls.

The complete water removal from the organic-phase initiated polyHIPEs indicates a sufficiently open-cell microstructure for water transport. The small endotherms in PB-50/B/SF and PB-70/B/SF (FIG. 1) reflect the dehydration of the alginate.

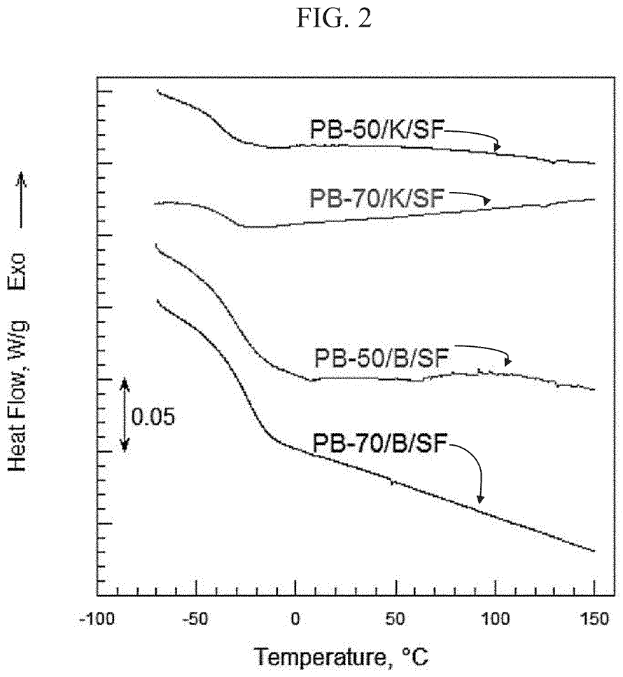

FIG. 2 presents DSC thermograms (second heat) of the surfactant-stabilized polyHIPEs, according to some embodiments of the present invention, comparing the effect of the locus of polymerization initiation on water retention.

The relatively low T_{g} values seen in Table 3 are typical of elastomeric polymers such as PEHA and PB. The T_{g} is affected by the extent of crosslinking and the monomer composition. It is noted herein that PBs are reported as exhibiting T_{g}s ranging from −25° C. to −12° C. that are higher than that reported for PEHA (−52° C.); therefore, the T_{g} is expected to increase with the increase in the PB content, regardless of the crosslinking. As mentioned above, the location of the initiator and the crosslinking comonomer in different phases in interfacially initiated polyHIPEs can result in a lower crosslinking density. It is noted that if the initiation is at the interface and the crosslinker (oligomer) is more hydrophobic than the monomer, the interface is crosslinker-poor, leading to reduced crosslinking level at or near the interface. The higher extent of initiator-crosslinker reactions in the organic-phase initiated polyHIPEs produces higher T_{g}s for the same compositions, as can be clearly seen in FIG. 2. For the same PB content, the organic-phase initiated polyHIPEs exhibited higher T_{g}s, due to the higher extent of crosslinking. For both loci of initiation, the T_{g}s increase slightly with increasing PB content, reflecting the higher T_{g} of PB, and perhaps, an increase in the crosslinking level. However, it is clear that the increase in T_{g} from the change in the locus of initiation is larger than the increase from the PB content, emphasizing the importance of the locus of initiation.

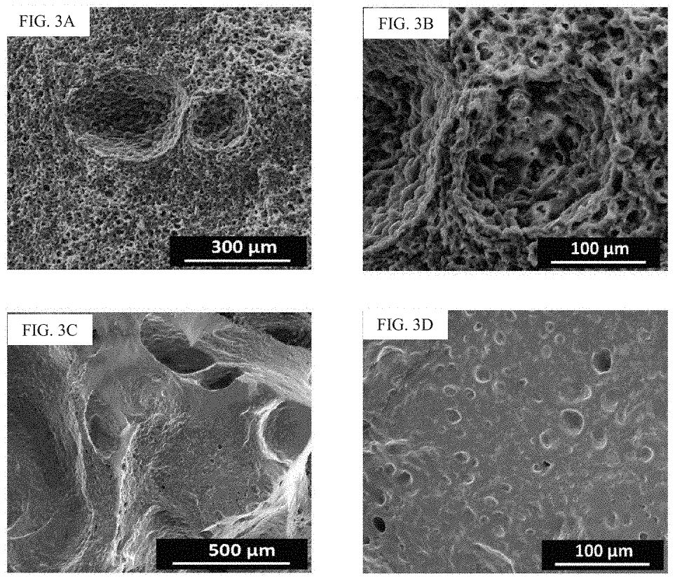

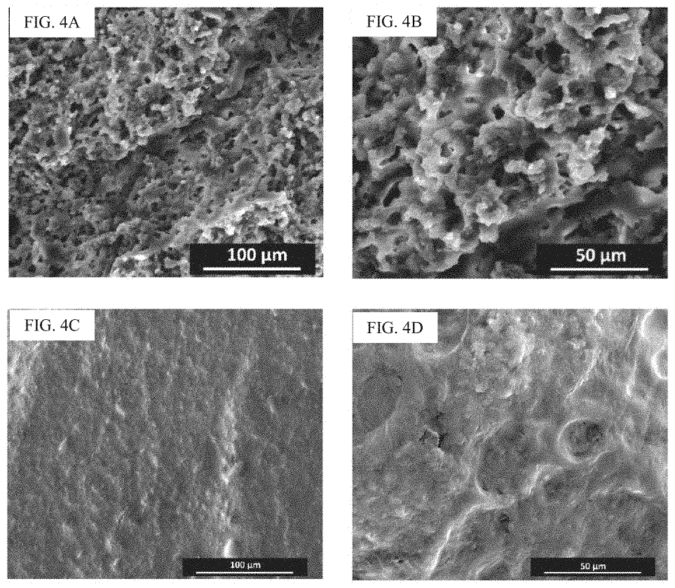

The cryogenic fracture surfaces of the surfactant-stabilized EHA-PB copolymer polyHIPEs polymerized using either interfacial initiation or organic-phase initiation are seen in FIGS. 3A-D and FIGS. 4A-D.

FIGS. 3A-D present SEM micrographs of cryogenic fracture surfaces of exemplary sample PB-30/B/SF (FIGS. 3A-B) and exemplary sample PB-30/K/SF (FIGS. 3C-D).

FIGS. 4A-D present SEM micrographs of cryogenic fracture surfaces of exemplary sample PB-70/B/SF (FIGS. 4A-B) and exemplary sample PB-70/K/SF (FIGS. 4C-D).

As can be seen in FIGS. 3A-D and FIGS. 4A-D, the organic-phase initiation yields structures that are clearly porous (FIGS. 3A-B and FIGS. 4A-B) while the interfacially initiated polyHIPEs do not exhibit interconnecting holes typical of open-cell polyHIPEs (FIGS. 3C-D and FIGS. 4C-D). PB-50/B/SF and PB-70/B/SF exhibited similar porous structures (FIGS. 3A-B and FIGS. 4A-B). These relatively open-cell porous structures are responsible for the complete evaporation of the water. As seen in FIGS. 3C-D and FIGS. 4C-D, the void walls of the interfacially initiated polyHIPEs, PB-50/K/SF and PB-70/K/SF, seem to have almost fully collapsed. This extent of collapse is a result of the highly elastomeric behavior of the interfacially initiated polyHIPEs. The water storage behavior of the interfacially initiated polyHIPEs, compared to the lack of water in the organic-phase initiated polyHIPEs, confirms the significant effects of the locus of initiation on the macromolecular structures of the polyHIPEs synthesized using free radical initiation within surfactant-stabilized HIPEs.

It is noted herein, without being bound by any particular theory, that the walls of the PB-x/B/SF may have also undergone collapse to some extent. The moduli of all demonstrated polyHIPEs are relatively low, and the difference is that they still exhibit a rough, porous structure, while the PB-x/K/SF do not exhibit such a structure. It is, therefore, more definitive to base the structural definition “truly-closed-cell microstructure” on water retention/loss rather than on visual inspection of the microstructure, regardless of magnification and technique.

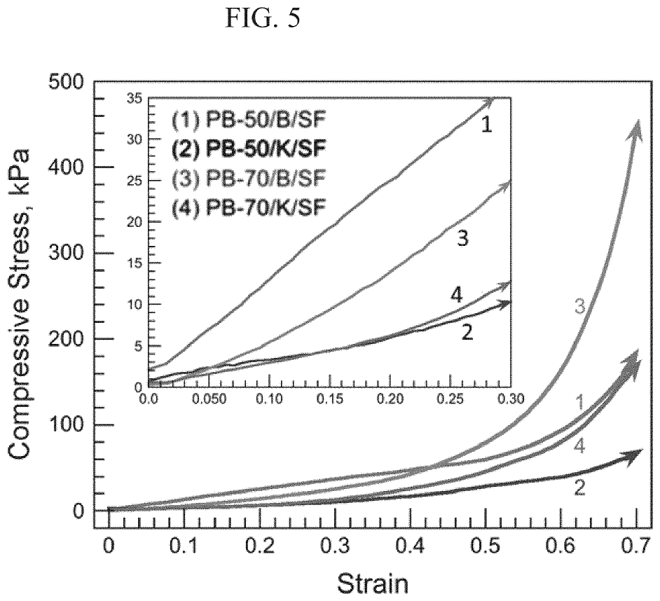

FIG. 5 presents plots of compressive stress-strain curves for exemplary surfactant-stabilized polyHIPEs, according to some embodiments of the present invention.

The inset shows the data for low stresses and strains.

As seen in Table 3 and in FIG. 5, the interfacially initiated polyHIPEs exhibited lower moduli, reflecting their more elastomeric nature, resulting from lower extents of crosslinking. In addition, the modulus (from rubber elasticity) decreases significantly with increasing PB content, which would indicate that the crosslinking is reduced and/or that PB is more elastomeric than the PEHA. The higher stress at 70% strain in the organic-phase initiated polyHIPEs most likely reflects the differences in the deformation mechanisms. The organic-phase initiated polyHIPEs with no water collapse accordion-like, while the interfacially initiated polyHIPEs deform barrel-like. Given the density of about 0.33 g/cc for the organic-phase initiated polyHIPEs, the polyHIPEs would be fully dense upon reaching strains of around 70% and would act like an elastomeric solid. For polyHIPEs with a density of 0.15 g/cc, the density at 70% strain would be 0.5 g/cc, which would still leave room for additional accordion-like deformation.

All the exemplary polyHIPEs demonstrated herein released some entrapped water during compression, and at the end of the compressive stress-strain measurements, none of the polyHIPEs returned to their initial shapes.

In summary, the locus of initiation has been shown to have a significant effect upon the macromolecular structure, the wall structure, the porous structure, the water retention, the thermal properties, and the mechanical properties of the polyHIPEs from surfactant-stabilized HIPEs. Some of these properties originate in the degree of crosslinking, which is strongly affected by the locus of initiation, for polyHIPEs from surfactant-stabilized HIPEs. The presence of the initiator in the aqueous phase and the relative hydrophobicity of the crosslinking comonomer in interfacially initiated polyHIPEs leads to a relatively low extent of cros slinking.

In the exemplary demonstrated polyHIPEs from surfactant-stabilized HIPEs it has been shown that interfacial initiation leads to more elastomeric and more closed-cell systems, enhancing water retention and resulting in higher densities. It is noted that the term “collapse” refers to the outer surface when using a SEM fracture surface micrograph to study the microstructure of the sample. Organic-phase initiation, on the other hand, leads to an open-cell structure more similar to a typical polyHIPE, and therefore, to less water retention, a higher modulus, and a higher stress at 70% strain.

Conclusive Remarks:

Several novel elastomeric, emulsion-templated polyHIPE systems, according to some embodiments of the present invention, were successfully synthesized and studied. The novel aspects of such systems found in this studies included demonstrating that: HIPEs can be formed when the minor external phase is extremely viscous. Large differences between HIPE phase viscosities can destabilize HIPEs. The breakthrough that enabled HIPE formation in such systems was the introduction of a polysaccharide into the internal phase such that its viscosity would be closer to that of the external phase; Innovative families of polyHIPEs containing extremely viscous oligomers in the HIPE's external, organic phase could, therefore, were successfully synthesized. PolyHIPE synthesis in such extremely viscous HIPEs was effected through free radical polymerization (FRP);

The locus of FRP initiation strongly affected the degree of crosslinking; and Relatively high densities can result from the polyHIPE' s ability to store water or from the partial collapse of the polyHIPE during drying. Interfacially initiated polyHIPEs exhibited truly-closed-cell microstructures, which “lock-in” the aqueous phase. Highly elastomeric polyHIPEs with relatively low extents of crosslinking and with open-cell or not truly closed-cell structures are more likely to undergo a partial collapse during drying; PolyHIPE copolymers of EHA and PB, polymerized using FRP, were successfully synthesized within surfactant-stabilized HIPEs.

Interfacial initiation for surfactant-stabilized HIPEs produced truly-closed-cell porous structures and relatively elastomeric polyHIPEs with enhanced water retention, and relatively low moduli;

Organic-phase initiated polyHIPEs from surfactant-stabilized HIPEs produced an open-cell structure that did not exhibit water retention; and

Higher crosslinking level, expressed by higher T_{g}s and higher moduli, were obtained for the organic-phase initiated polyHIPEs since the pendent double bonds in the relatively hydrophobic PB were more likely to react.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-50. (canceled)

51. A composition-of-matter comprising a continuous elastomeric matrix and a liquid dispersed in said elastomeric matrix in a form of a plurality of discrete liquid-filled voids, wherein said liquid comprises a thickening agent, said elastomeric matrix is structurally-templated by an external phase of a high internal phase emulsion (HIPE) and entrapping said liquid in said voids, and structurally characterized by a truly-closed-cell microstructure.

52. The composition-of-matter of claim 51, wherein said elastomeric matrix is a copolymer that comprises a plurality of residues of at least one oligomer having a plurality of pendent reactive functional groups.

53. The composition-of-matter of claim 52, wherein said elastomeric matrix is a copolymer comprises a plurality of residues of at least one monomer characterized by forming a homopolymer having a T_{g} lower than 30±5° C.

54. The composition-of-matter of claim 51, wherein said truly-closed-cell microstructure is characterized by a liquid retention of at least 40±4% by weight during at least 3 days under freeze drying conditions.

55. The composition-of-matter of claim 51, wherein said liquid is characterized by a viscosity that ranges from 10 cp to 10,000 cp.

56. The composition-of-matter of claim 51, wherein said liquid comprises at least one releasable substance.

57. The composition-of-matter of claim 51, wherein said elastomer further comprises at least one degradable polymer, oligomer and/or crosslinking agent.

58. A process of preparing the composition-of-matter of claim 51, the process comprising subjecting a high internal phase emulsion (HIPE) having an aqueous internal phase and an organic polymerizable external phase to polymerization of said polymerizable external phase, wherein said aqueous internal phase further comprises a thickening agent said internal phase and said polymerizable external phase are each essentially devoid of said HIPE-stabilizing particles, and said polymerization being initiated substantially at an interface between said polymerizable external phase and said internal phase.

59. The process of claim 58, wherein a concentration of said thickening agent is selected such that a ratio V_{org}/V_{aq} ranges from 1,000 to 0.001.

60. The process of claim 58, wherein said organic polymerizable external phase comprises a surfactant.

61. The process of claim 58, wherein said aqueous internal phase further comprises a water-soluble polymerization initiation agent.

62. The process of claim 58, wherein said organic polymerizable external phase is a pre-polymerization mixture which comprises at least one monomer characterized by forming a homopolymer having an elastic modulus of less than 600±60 MPa.

63. The process of claim 58, wherein said organic polymerizable external phase is a pre-polymerization mixture which comprises at least one monomer characterized by forming a homopolymer having a Tg lower than 30±5° C.

64. The process of claim 62, wherein said organic polymerizable external phase is a pre-polymerization mixture which comprises at least one oligomer characterized by an average molecular weight that ranges from 500±50 g/mol to 10,000±1,000 g/mol and further characterized by having a plurality of pendent reactive functional groups.

65. The process of claim 58, wherein said pre-polymerized mixture further comprises a reinforcing agent, a curing agent, a curing accelerator, a catalyst, a tackifier, a plasticizer, a flame retardant, a flow control agent, a filler, organic and inorganic microspheres, organic and inorganic microparticles, organic and inorganic nanoparticles, a conducting agent, a magnetic agent, electrically conductive particles, thermally conductive particles, fibers, an antistatic agent, a antioxidant, a anticorrosion agent, a UV absorber, a colorant and combination thereof.

66. An article-of-manufacturing comprising the composition-of-matter of claim 51.

67. The article-of-manufacturing of claim 66, selected from the group consisting of an agricultural product, an energy absorption and dissipation article, a vibration absorption article, a noise absorption article, a cushioning article, a thermal insulating article, an impact protection article, dampening material, moisture and humidity control material, fire resistant material and any combination thereof.

68. A substance-releasing system comprising the composition-of-matter of claim 56.

69. The system of claim 68, being a degradable system.
